(19) United States
(12) Patent Application Publication
(10) Pub. No.: US 2024/0043322 A1
(43) Pub. Date: Feb. 8, 2024

(54) METHOD FOR PRODUCING A MINERAL WOOL PRODUCT

(71) Applicant: Rockwool A/S, Hedehusene (DK)

(72) Inventor: Thomas Hjelmgaard, Hedehusene (DK)

(21) Appl. No.: 18/277,485

(22) PCT Filed: Feb. 16, 2022
(86) PCT No.: PCT/EP2022/053791

§ 371 Date: Aug. 16, 2023

(30) Foreign Application Priority Data
Feb. 16, 2021 (EP) 21157501.4

(51) Int. Cl. C03C 25/26; C03C 25/1095; C03C 25/255; C03B 37/04; D04H 1/4209; D04H 1/64; D04H 1/587; C08L 89/06; C08K 5/103; C08K 7/14

(52) U.S. Cl. CPC C03C 25/26; C03C 25/1095; C03C 25/255; C03B 37/04; D04H 1/4209; D04H 1/64; D04H 1/587; C08L 89/06; C08K 5/103; C08K 7/14; C08L 2207/32

(57) ABSTRACT

Please substitute the following paragraph(s) for the abstract now appearing in the currently filed specification:

A method for producing a mineral wool product includes contacting mineral fibres with a formaldehyde-free binder composition for mineral fibres.

### CROSS-REFERENCE TO RELATED APPLICATIONS

This application is the U.S. National Stage of PCT/EP2022/053791 filed on Feb. 16, 2022, which claims priority to European Patent Application 21157501.4 filed on Feb. 16, 2021, the entire content of both are incorporated herein by reference in their entirety.

### FIELD OF THE INVENTION

The present invention relates to a method of producing a mineral wool product which comprises the step of contacting mineral fibres with a binder composition, and a mineral wool product prepared by the method.

### BACKGROUND OF THE INVENTION

Mineral wool products generally comprise man-made vitreous fibres (MMVF) such as, e.g., glass fibres, ceramic fibres, basalt fibres, slag wool, mineral wool and stone wool (rock wool), which are bonded together by a cured thermoset polymeric binder material. For use as thermal or acoustical insulation products, bonded mineral fibre mats are generally produced by converting a melt made of suitable raw materials to fibres in conventional manner, for instance by a spinning cup process or by a cascade rotor process. The fibres are blown into a forming chamber and, while airborne and while still hot, are sprayed with a binder solution and randomly deposited as a mat or web onto a travelling conveyor. The fibre mat is then transferred to a curing oven where heated air is blown through the mat to cure the binder and rigidly bond the mineral fibres together.

In the past, the binder resins of choice have been phenol-formaldehyde resins which can be economically produced and can be extended with urea prior to use as a binder. However, the existing and proposed legislation directed to the lowering or elimination of formaldehyde emissions have led to the development of formaldehyde-free binders such as, for instance, the binder compositions based on polycarboxy polymers and polyols or polyamines, such as disclosed in EP-A-583086, EP-A-990727, EP-A-1741726, U.S. Pat. No. 5,318,990 and US-A-2007/0173588.

Another group of non-phenol-formaldehyde binders are the addition/-elimination reaction products of aliphatic and/or aromatic anhydrides with alkanolamines, e.g., as disclosed in WO 99/36368, WO 01/05725, WO 01/96460, WO 02/06178, WO 2004/007615 and WO 2006/061249. These binder compositions are water soluble and exhibit excellent binding properties in terms of curing speed and curing density. WO 2008/023032 discloses urea-modified binders of that type, which provide mineral wool products having reduced moisture take-up.

Since some of the starting materials used in the production of these binders are rather expensive chemicals, there is an ongoing need to provide formaldehyde-free binders, which are economically produced.

A further effect in connection with previously known aqueous binder compositions for mineral fibres is that at least the majority of the starting materials used for the productions of these binders stem from fossil fuels. There is an ongoing trend of consumers to prefer products that are fully or at least partly produced from renewable materials and there is therefore a need to provide binders for mineral wool, which are at least partly produced from renewable materials.

A further effect in connection with previously known aqueous binder compositions for mineral fibres is that they involve components, which are corrosive and/or harmful. This requires protective measures for the machinery involved in the production of mineral wool products to prevent corrosion and also requires safety measures for the persons handling this machinery. This leads to increased costs and health issues and there is therefore a need to provide binder compositions for mineral fibres with a reduced content of corrosive and/or harmful materials.

Such aqueous binder compositions are used in methods for preparing mineral wool products by applying the aqueous binder compositions to mineral fibres. An important factor in these methods, apart from the aqueous binder used, is the curing temperature used in the method.

Generally, low curing temperatures are desirable, because they allow inexpensive curing equipment and a low energy consumption during the curing process, both of which are economically advantageous. Another advantage of applying low curing temperatures is that they are expected to result in lower emission of harmful gases during the curing process which again allows for less costly equipment to be used in the curing process.

On the other hand, high curing temperatures allow for relatively fast curing times and a relatively high completion of the curing process, which is expected to result in good mechanical properties.

Accordingly, there is still a need to provide a method for preparing mineral wool products, which employs an aqueous binder composition prepared to a large part from renewable materials which are not corrosive or harmful and in the process of which only a small amount of harmful gases are produced and at the same time the mineral wool product resulting from the curing has very good mechanical properties.

### SUMMARY OF THE INVENTION

Accordingly, it was an object of the present invention to provide a method for preparing a mineral wool product which comprise the step of contacting mineral fibres with a binder composition for mineral fibres which uses renewable materials as starting materials and reduces or eliminates corrosive and/or harmful materials, minimizes harmful emissions during the curing process and at the same time allow improved properties of the mineral wool products produced by the method.

Further, it was an object of the present invention to provide a mineral wool product prepared by this method.

In accordance with a first aspect of the present invention, there is provided a method for producing a mineral wool product which comprises the steps of contacting mineral fibres with a formaldehyde-free binder composition for mineral fibres comprising:
at least one phenol containing compound,
at least one protein,
and curing the binder composition preferably at a temperature of 150° C.-250° C., such as >150° C.-250° C., such as 175° C.-225° C., such as up to 220° C., such as up to 215° C.

In accordance with a second aspect of the present invention, there is provided a mineral wool product produced by this method.

The present inventors have surprisingly found that it is possible to provide a method for producing a mineral wool product which uses a binder composition prepared from renewable materials and allows for a curing step in a specific temperature range which enables very low emissions during the curing process and at the same time achieves excellent mechanical properties of the resulting mineral wool product.

The present inventors have found that when using the curing temperature described above in the curing step, it is easier to carry out the curing step in an online process when compared to a curing step conducted at lower temperature like e.g. room temperature.

### DESCRIPTION OF THE PREFERRED EMBODIMENTS

The present invention is directed to a method for producing a mineral wool product which comprises the steps of contacting mineral fibres with a binder composition for mineral fibres comprising:
at least one phenol containing compound,
at least one protein,
and curing the binder composition at a temperature of 150° C.-250° C., such as >150° C.-250° C., such as 175° C.-225° C., such as up to 220° C., such as up to 215° C.

In a preferred embodiment, the method according to the present invention comprises the step of applying a formaldehyde-free binder composition.

For the purpose of the present application, the term “formaldehyde free” is defined to characterize a mineral wool product where the emission is below 5 μg/m²/h of formaldehyde from the mineral wool product, preferably below 3 μg/m²/h. Preferably, the test is carried out in accordance with ISO 16000 for testing aldehyde emissions.

The present inventors have surprisingly found that by employing the temperature range 150° C.-250° C., such as >150° C.-250° C., such as 175° C.-225° C., such as up to 220° C., such as up to 215° C. for the curing step in the method according to the present invention, a very advantageous combination of features of fast curing, low emission of harmful gases during the curing process and excellent mechanical properties of the mineral wool product resulting from the method can be achieved.

Phenol containing compound component of the binder

The binder composition according to the method of the present invention comprises a phenol containing compound component of the binder, in particular one or more phenolic compounds.

Phenolic compounds, or phenolics, are compounds that have one or more hydroxyl group attached directly to an aromatic ring. Polyphenols (or polyhydroxyphenols) are compounds that have more than one phenolic hydroxyl group attached to one or more aromatic rings. Phenolic compounds are characteristic of plants and as a group they are usually found as esters or glycosides rather than as free compounds.

The term phenolics covers a very large and diverse group of chemical compounds. Preferably, the phenol containing compound is a compound according to the scheme based on the number of carbons in the molecule as detailed in by W. Vermerris, R. Nicholson, in Phenolic Compound Biochemistry, Springer Netherlands, 2008.

In one embodiment, the phenol containing compound comprises a phenol containing compound such as simple phenolics, such as hydroxybenzoic acids, such as hydroxybenzoic aldehydes, such as hydroxyacetophenones, such as hydroxyphenylacetic acids, such as cinnamic acids, such as cinnamic acid esters, such as cinnamyl aldehydes, such as cinnamyl alcohols, such as coumarins, such as isocoumarins, such as chromones, such as flavonoids, such as chalcones, such as dihydrochalcones, such as aurones, such as flavanones, such as flavanonols, such as flavans, such as leucoanthocyanidins, such as flavan-3-ols, such as flavones, such as anthocyanidins, such as deoxyanthocyanidines, such as anthocyanins, such as biflavonyls, such as benzophenones, such as xanthones, such as stilbenes, such as betacyanins, such as polyphenols and/or polyhydroxyphenols, such as lignans, neolignans (dimers or oligomers from coupling of monolignols such as p-coumaryl alcohol, coniferyl alcohol and sinapyl alcohol), such as lignins (synthesized primarily from the monolignol precursors p-coumaryl alcohol, coniferyl alcohol and sinapyl alcohol), such as tannins, such as tannates (salts of tannins), such as condensed tannins (proanthocyanidins), such as hydrolysable tannins, such as gallotannins, such as ellagitannins, such as complex tannins, such as tannic acid, such as phlobabenes, such as phlorotannins, such as sulfonated phenolic containing compounds.

In one embodiment, the phenol containing compound is selected from the group consisting of simple phenolics, phenol containing compounds with a more complex structure than a C₆ structure, such as oligomers of simple phenolics, polyphenols, and/or polyhydroxyphenols.

The phenol containing compounds according to the method of the present invention can also be synthetic or semisynthetic molecules or constructs that contain phenols, polyphenols. An example for such a construct is a protein, peptide, peptoids (such as linear and/or cyclic oligomers and/or polymers of N-substituted glycines, N-substituted β-alanines), or arylopeptoids (such as linear and/or cyclic oligomers and/or polymers of N-substituted aminomethyl benzamides) modified with phenol containing side chains. A dendrimer decorated with phenol containing side chains is another example.

In one embodiment, the phenol containing compound according to the method of the present invention is a quinone. Quinones are oxidized derivatives of aromatic compounds and are often readily made from reactive aromatic compounds with electron-donating substituents such as phenolics. Quinones useful for the present invention include benzoquinones, napthoquinone, anthraquinone and lawsone.

Tannins comprise a group of compounds with a wide diversity in structure that share their ability to bind and precipitate proteins. Tannins are abundant in many different plant species, in particular oak, chestnut, staghorn sumac and fringe cups. Tannins can be present in the leaves, bark and fruits. Tannins can be classified into three groups: condensed tannins, hydrolysable tannins and complex tannins. Condensed tannins, or proanthocyanidins, are oligomeric or polymeric flavonoids consisting of flavan-3-ol (catechin) units. Gallotannins are hydrolysable tannins with a polyol core substituted with 10-12 gallic acid residues. The most commonly found polyol in gallotannins is D-glucose although some gallotannins contain catechin and triterpenoid units as the core polyol. Ellagitanins are hydrolysable tannins that differ from gallotannins in that they contain additional C—C bonds between adjacent galloyl moieties. Complex tannins are defined as tannins in which a catechin unit is bound glycosidically to either a gallotannin or an ellagitannin unit.

In one embodiment, the tannin is selected from one or more components from the group consisting of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

The inventors have found that a wide range of such phenol containing compounds can be used in order to obtain binder compositions which can be used in the method according to the present invention with excellent results. Often, these phenol containing compound components are obtained from vegetable tissues and are therefore a renewable material. In some embodiments, the compounds are also non-toxic and non-corrosive. As a further advantage, these compounds are antimicrobial and therefore impart their antimicrobial properties to the mineral wool product bound by such a binder.

Protein Component of the Binder

Preferably, the protein component of the binder used in the method according to the present invention is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin, such as mussel foot protein; proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; polyphenolic proteins such as mussel foot protein.

Collagen is a very abundant material in living tissue: It is the main component in connective tissue and constitutes 25-35% of the total protein content in mammals. Gelatin is derived from chemical degradation of collagen. Gelatin may also be produced by recombinant techniques. Gelatin is water soluble and has a molecular weight of 10.000 to 500.000 g/mol, such as 30.000 to 300.000 g/mol dependent on the grade of hydrolysis. Gelatin is a widely used food product and it is therefore generally accepted that this compound is totally non-toxic and therefore no precautions are to be taken when handling gelatin.

Gelatin is a heterogeneous mixture of single or multi-stranded polypeptides, typically showing helix structures. Specifically, the triple helix of type I collagen extracted from skin and bones, as a source for gelatin, is composed of two α1(I) and one α2(I) chains.

Gelatin solutions may undergo coil-helix transitions.

A type gelatins are produced by acidic treatment. B type gelatins are produced by basic treatment.

Chemical cross-links may be introduced to gelatin. In one embodiment, transglutaminase is used to link lysine to glutamine residues; in one embodiment,

glutaraldehyde is used to link lysine to lysine, in one embodiment, tannins are used to link nucleophilic residues, such as lysine residues.

The gelatin can also be further hydrolysed to smaller fragments of down to 3000 g/mol.

On cooling a gelatin solution, collagen like helices may be formed. Gelatin may form helix structures.

In one embodiment, the cured binder comprising protein comprises helix structures.

In one embodiment, the at least one protein is a low strength gelatin, such as a gelatin having a gel strength of 30 to 125 Bloom.

In one embodiment, the at least one protein is a medium strength gelatin, such as a gelatin having a gel strength of 125 to 180 Bloom.

In one embodiment, the at least one protein is a high strength gelatin, such as a gelatin having a gel strength of 180 to 300 Bloom.

In a preferred embodiment, the gelatin is preferably originating from one or more sources from the group consisting of mammal, bird species, such as from cow, pig, horse, fowl, and/or from scales, skin of fish.

Without wanting to be bound by any specific theory, the inventors of the present invention believe that the surprisingly good results achieved by the method according to the present invention are at least partly due to a denaturation process of the at least one protein in the binders described.

Denaturation is a process in which the proteins lose the quaternary structure, tertiary structure, and/or secondary structure which is present in their native state.

It is believed that the specific curing temperatures used in the method according to the present invention make such a denaturation process feasible and this contributes to the excellent properties of the mineral wool products resulting from the method according to the present invention.

In one embodiment, urea may be added to the binder compositions according to the present invention. The inventors have found that the addition of even small amounts of urea causes denaturation of the gelatin, which can slow down the gelling, which might be desired in some embodiments. The addition of urea might also lead to a softening of the product.

The inventors have found that the carboxylic acid groups in gelatins interact strongly with trivalent and tetravalent ions, for example aluminum salts. This is especially true for type B gelatins which contain more carboxylic acid groups than type A gelatins.

The inventors have found that starting the curing at low temperatures may lead to stronger products. Without being bound to any particular theory, it is assumed by the inventors that starting curing at high temperatures may lead to an impenetrable outer shell of the binder composition which hinders water from underneath to get out.

Surprisingly, the mineral wool products prepared by the method according to the present invention for the use of binders including gelatins are very heat resistant. The present inventors have found that in some embodiments the mineral wool products can sustain temperatures of up to 250° C. without degradation.

In one embodiment, the method according to the present invention comprises the steps of:
making a melt of raw materials,
fibrerising the melt by means of a fibre forming apparatus to form mineral fibres,
providing the mineral fibres in the form of a collected web,
mixing the binder with the mineral fibres before, during or after the provision
of the collected web to form a mixture of mineral fibres and binder,
curing the mixture of mineral fibres and binder.

In one embodiment, the present invention is directed to a method for producing a mineral wool product which comprises the steps of
making a melt of raw materials,
fibrerising the melt by means of a fibre forming apparatus to form mineral fibres,
providing the mineral fibres in the form of a collected web,
contacting the mineral fibres with a formaldehyde-free binder composition for mineral fibres comprising
   a. at least one phenol-containing compound,
   b. at least one protein,
and curing the binder composition at a temperature of 150° C.-250° C., such as >150° C.-250° C., such as 175° C.-225° C., such as up to 220° C., such as up to 215° C.

In one embodiment, the method according to the present invention is carried out such that the at least one phenol containing compound comprises a phenol containing compound such as simple phenolics, such as hydroxybenzoic acids, such as hydroxybenzoic aldehydes, such as hydroxyacetophenones, such as hydroxyphenylacetic acids, such as cinnamic acids, such as cinnamic acid esters, such as cinnamyl aldehydes, such as cinnamyl alcohols, such as coumarins, such as isocoumarins, such as chromones, such as flavonoids, such as chalcones, such as dihydrochalcones, such as aurones, such as flavanones, such as flavanonols, such as flavans, such as leucoanthocyanidins, such as flavan-3-ols, such as flavones, such as anthocyanidins, such as deoxyanthocyanidines, such as anthocyanins, such as biflavonyls, such as benzophenones, such as xanthones, such as stilbenes, such as betacyanins, such as polyphenols and/or polyhydroxyphenols, such as lignans, neolignans (dimers or oligomers from coupling of monolignols such as p-coumaryl alcohol, coniferyl alcohol and sinapyl alcohol), such as lignins (synthesized primarily from the monolignol precursors p-coumaryl alcohol, coniferyl alcohol and sinapyl alcohol), such as tannins, such as tannates (salts of tannins), such as condensed tannins (proanthocyanidins), such as hydrolysable tannins, such as gallotannins, such as ellagitannins, such as complex tannins, such as tannic acid, such as phlobabenes, such as phlorotannins, such as sulfonated phenolic containing compounds.

In one embodiment, the method according to the present invention is carried out such that the tannin is selected from one or more components from the group consisting of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

In one embodiment, the method according to the present invention is carried out such that the phenol containing compound comprises one or more synthetic or semisynthetic molecules that contain phenols, polyphenols, such as a proteins, peptides, peptoids or arylopeptoids modified with phenol containing side chains, such as dendrimers decorated with phenol containing side chains.

In one embodiment, the method according to the present invention is carried out such that the content of the at least one phenol containing compound, such as in form of tannin is 1 to 60 wt. %, such as 2 to 60 wt. %, such as 3 to 50 wt. %, such as 4 to 40 wt. %, such as 5 to 35 wt. %, such as 2.5 to 15 wt. %, such as 4 to 12 wt. %, based on dry protein basis.

In one embodiment, the method according to the present invention is carried out such that the at least one protein is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; polyphenolic proteins such as mussel foot protein.

In one embodiment, the method according to the present invention is carried out such that the binder composition comprises at least two proteins, wherein one protein is at least one selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin, such as mussel foot protein; and another protein is at least one protein selected from group of proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds.

In one embodiment, the method according to the present invention is carried out with the proviso that the aqueous binder composition does not comprise a protein from soybeans (soy protein).

In one embodiment, the method according to the present invention is carried out such that the protein contains 50 to 400, such as 100 to 300 (hydroxy proline+proline) residues per 1000 amino acid residues.

In one embodiment, the method according to the present invention is carried out such that the binder composition further comprises an additive selected from the group of and oxidiser, such as tyrosinase, a pH-adjuster, preferably in form of a base, such as organic base, such as amine or salts thereof, inorganic bases, such as lithium hydroxide and/or sodium hydroxide and/or potassium hydroxide, such as in an amount of 0.01 to 10 wt. %, such as 0.05 to 6 wt. %, based on the combined dry weight of phenol containing compound and protein, such as ammonia or salts thereof.

In one embodiment, the method according to the present invention is carried out such that the binder composition has a pH of 4.5 to 9.5, such as 6.0 to 8.0.

In one embodiment, the method according to the present invention is carried out such that the content of the at least one protein is 1 to 99 wt. %, such as 3 to 97 wt. %, such as 5 to 95 wt. %, such as 10 to 90 wt. %, such as 10 to 80 wt. %, based on the content of the at least one phenol containing compound and the at least one protein.

Method in which the binder comprises at least one divalent metal cation M²⁺ containing compound

The present inventors have surprisingly found that the method according to the present invention can be further improved when the binder comprises at least one divalent metal cation M²⁺ containing compound. In one embodiment, the method according to the present invention comprises the steps of:
contacting mineral fibres with a formaldehyde-free binder composition for mineral fibres comprising:
at least one phenol containing compound,
at least one protein,
and curing the binder composition at a temperature of >150° C.-250° C., such as 175° C.-225° C., such as up to 220° C., such as up to 215° C., wherein
   the at least one phenol containing compound is a tannin is selected from one or more components from the group consisting of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus,
   the at least one protein is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin, such as mussel foot protein; proteins from vegetable sources not comprising soybeans (soy protein), including proteins from algae, legumes, cereals, whole grains, nuts, seeds and fruits, like protein from buckwheat, oats, rye, millet, maize (corn), rice, wheat, bulgur, sorghum, amaranth, quinoa, lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; polyphenolic proteins such as mussel foot protein.

Reaction of the Binder Components

Without wanting to be bound to any particular theory, the present inventors believe that the reaction between the phenol containing compound and the protein at least partly relies on an oxidation of phenols to quinones followed by nucleophilic attack of nucleophilic groups, such as amine and/or thiol groups from the protein which leads to a crosslinking and/or modification of the proteins by the phenol containing compounds.

Without wanting to be bound by any particular theory, the present inventors believe that the improvement of the properties of the mineral wool products prepared by the method according to the present invention due to the presence of the divalent metal cation M²⁺ containing compound can be explained by a chelation-effect, in which the M²⁺ crosslinks negatively charge groups of the cured binder.

In one embodiment, the method according to the present invention is carried out such that the binder comprises at least one divalent metal cation M²⁺ containing compound.

In one embodiment, the method according to the present invention is carried out such that the at least one divalent metal cation M²⁺ containing compound comprises one or more divalent metal cations M²⁺ selected from the group of divalent cations of earth alkaline metals, Mn, Fe, Cu, Zn, Sn.

In one embodiment, the method according to the present invention is carried out such that the divalent metal cation containing compound comprises Ca²⁺.

In one embodiment, the method according to the present invention is carried out such that the binder composition comprises the at least one divalent metal cation compound in an amount of 0.1 wt. % to 10 wt. %, such as 0.2 wt. % to 8 wt. %, such as 0.3 wt. % to 5 wt. %, such as 0.4 wt. % to 4.3 wt. %, such as 1.0 wt. % to 4.3 wt. %, based on the combined dry weight of phenol containing compound and protein.

By providing at least one divalent metal cation M²⁺ containing compound and at least one monovalent metal cation M⁺ containing compound, the cross-linking effect can, according to the theory of the inventors, be modulated and the properties of the mineral wool products can be tailor-made.

Method in which the binder composition further comprises at least one fatty acid ester of glycerol

In one embodiment, the method according to the present invention employs a binder composition which comprises a component in form of at least one fatty acid ester of glycerol.

A fatty acid is a carboxylic acid with an aliphatic chain, which is either saturated or unsaturated.

Glycerol is a polyol compound having the IUPAC name propane-1,2,3-triol.

Naturally occurring fats and oils are glycerol esters with fatty acids (also called triglycerides).

For the purpose of the present invention, the term fatty acid ester of glycerol refers to mono-, di-, and tri-esters of glycerol with fatty acids.

While the term fatty acid can in the context of the present invention be any carboxylic acid with an aliphatic chain, it is preferred that it is carboxylic acid with an aliphatic chain having 4 to 28 carbon atoms, preferably of an even number of carbon atoms. Preferably, the aliphatic chain of the fatty acid is unbranched.

In a preferred embodiment, the at least one fatty acid ester of glycerol is in form of a plant oil and/or animal oil. In the context of the present invention, the term “oil” comprises at least one fatty acid ester of glycerol in the form of oils or fats.

In a preferred embodiment, the at least one fatty acid ester of glycerol is a plant-based oil.

In a preferred embodiment, the at least one fatty acid ester of glycerol is in form of fruit pulp fats such as palm oil, olive oil, avocado oil; seed-kernel fats such as lauric acid oils, such as coconut oil, palm kernel oil, babassu oil and other palm seed oils, other sources of lauric acid oils; palmitic-stearic acid oils such as cocoa butter, shea butter, borneo tallow and related fats (vegetable butters); palmitic acid oils such as cottonseed oil, kapok and related oils, pumpkin seed oil, corn (maize) oil, cereal oils; oleic-linoleic acid oils such as sunflower oil, sesame oil, linseed oil, perilla oil, hempseed oil, teaseed oil, safflower and niger seed oils, grape-seed oil, poppyseed oil, leguminous oil such as soybean oil, peanut oil, lupine oil; cruciferous oils such as rapeseed oil, mustard seed oil; conjugated acid oils such as tung oil and related oils, oiticica oil and related oils; substituted fatty acid oils such as castor oil, chaulmoogra, hydnocarpus and gorli oils, vernonia oil; animal fats such as land-animal fats such as lard, beef tallow, mutton tallow, horse fat, goose fat, chicken fat; marine oils such as whale oil and fish oil.

In a preferred embodiment, the at least one fatty acid ester of glycerol is in form of a plant oil, in particular selected from one or more components from the group consisting of linseed oil, coconut oil, corn oil, canola oil, cottonseed oil, olive oil, palm oil, peanut oil (ground nut oil), rapeseed oil, including canola oil, safflower oil, sesame oil, soybean oil, sunflower oil.

In a preferred embodiment, the at least one fatty acid ester of glycerol is selected from one or more components from the group consisting of a plant oil having an iodine number in the range of approximately 136 to 178, such as a linseed oil having an iodine number in the range of approximately 136 to 178, a plant oil having an iodine number in the range of approximately 80 to 88, such as an olive oil having an iodine number in the range of approximately 80 to 88, a plant oil having an iodine number in the range of approximately 163 to 173, such as tung oil having an iodine number in the range of approximately 163 to 173, a plant oil having an iodine number in the range of approximately 7 to 10, such as coconut oil having an iodine number in the range of approximately 7 to 10, a plant oil having an iodine number in the range of approximately 140 to 170, such as hemp oil having an iodine number in the range of approximately 140 to 170, a plant oil having an iodine number in the range of approximately 94 to 120, such as a rapeseed oil having an iodine number in the range of approximately 94 to 120, a plant oil having an iodine number in the range of approximately 118 to 144, such as a sunflower oil having an iodine number in the range of approximately 118 to 144.

In one embodiment, the at least one fatty acid ester of glycerol is not of natural origin.

In one embodiment, the at least one fatty acid ester of glycerol is a modified plant or animal oil.

In one embodiment, the at least one fatty acid ester of glycerol comprises at least one trans-fatty acid.

In an alternative preferred embodiment, the at least one fatty acid ester of glycerol is in form of an animal oil, such as a fish oil.

In one embodiment, the binder results from the curing of a binder composition comprising gelatin, and wherein the binder composition further comprises a tannin selected from one or more components from the group consisting of tannic acid, sulfonated tannins, condensed tannins (proanthocyanidins), hydrolysable tannins, gallotannins, ellagitannins, complex tannins, and/or tannin originating from one or more of oak, chestnut, staghorn sumac and fringe cups, preferably tannic acid, and the binder composition further comprises at least one fatty acid ester of glycerol, such as at least one fatty acid ester of glycerol selected from one or more components from the group consisting of linseed oil coconut oil, corn oil, canola oil, cottonseed oil, olive oil, palm oil, peanut oil (ground nut oil), rapeseed oil, including canola oil, safflower oil, sesame oil, soybean oil, sunflower oil.

The present inventors have found that the parameter for the fatty acid ester of glycerol used in the binders according to the present invention of the amount of unsaturation in the fatty acid can be used to distinguish preferred embodiments. The amount of unsaturation in fatty acids is usually measured by the iodine number (also called iodine value or iodine absorption value or iodine index). The higher the iodine number, the more C═C bonds are present in the fatty acid. For the determination of the iodine number as a measure of the unsaturation of fatty acids, we make reference to Thomas, Alfred (2012) “Fats and fatty oils” in Ullmann's Encyclopedia of industrial chemistry, Weinheim, Wiley-VCH.

In a preferred embodiment, the at least one fatty acid ester of glycerol comprises a plant oil and/or animal oil having an iodine number of 75, such as 75 to 180, such as 1.30, such as 130 to 180.

In an alternative preferred embodiment, the at least one fatty acid ester of glycerol comprises a plant oil and/or animal oil having an iodine number of 1.00, such as 25.

In one embodiment, the at least one fatty acid ester of glycerol is a drying oil. For a definition of a drying oil, see Poth, Ulrich (2012) “Drying oils and related products” in Ullmann's Encyclopedia of industrial chemistry, Weinheim, Wiley-VCH.

In one embodiment, the at least one fatty acid ester of glycerol is selected from one or more components from the group consisting of linseed oil, olive oil, tung oil, coconut oil, hemp oil, rapeseed oil, and sunflower oil.

Accordingly, the present inventors have found that particularly good results are achieved when the iodine number is either in a fairly high range or, alternatively, in a fairly low range. While not wanting to be bound by any particular theory, the present inventors assume that the advantageous properties inflicted by the fatty acid esters of high iodine number on the one hand and low iodine number on the other hand are based on different mechanisms. The present inventors assume that the advantageous properties of glycerol esters of fatty acids having a high iodine number might be due to the participation of the C═C double-bonds found in high numbers in these fatty acids in a crosslinking reaction, while the glycerol esters of fatty acids having a low iodine number and lacking high amounts of C═C double-bonds might allow a stabilization of the cured binder by van der Waals interactions. The present inventors assume that the polar end of glycerol esters of fatty acids interacts with polar areas of the at least one protein while non-polar ends interact with non-polar areas of the at least one protein.

In one embodiment, the method according to the present invention uses a binder composition, wherein the content of fatty acid ester of glycerol is 0.6 to 60, such as 0.5 to 40, such as 1 to 30, such as 1.5 to 16, such as 3 to 10, such as 4 to 7.5 wt.-% based on the dry weight of the at least one protein and the at least one phenol containing compound.

Additives

In a preferred embodiment, the method according to the present invention uses a binder composition which contains additives.

These additives may be components such as one or more reactive or nonreactive silicones and may be added to the binder. Preferably, the one or more reactive or nonreactive silicone is selected from the group consisting of silicone constituted of a main chain composed of organosiloxane residues, especially diphenylsiloxane residues, alkylsiloxane residues, preferably dimethylsiloxane residues, bearing at least one hydroxyl, acyl, carboxyl or anhydride, amine, epoxy or vinyl functional group capable of reacting with at least one of the constituents of the binder composition and is preferably present in an amount of 0.1-15 weight-%, preferably from 0.1-10 weight-%, more preferably 0.3-8 weight-%, based on the total binder mass.

In one embodiment, an emulsified hydrocarbon oil may be added to the binder.

As already described above, many phenol containing compounds, in particular polyphenols, have antimicrobial properties and therefore impart antimicrobial characteristic to the binder. Nevertheless, in one embodiment, an anti-fouling agent may be added to the binder compositions.

In one embodiment, an anti-swelling agent may be added to the binder, such as tannic acid and/or tannins.

In one embodiment, the binder composition according to the present invention contains additives in form of amine linkers and/or thiol/thiolate linkers. These additives in form of amine linkers and/or thiol/thiolate linkers are particular useful when the crosslinking reaction of the binder proceeds via the quinone-amine and/or quinone-thiol pathway.

In one embodiment, the binder compositions according to the present invention contain further additives in form of additives selected from the group consisting of PEG-type reagents, silanes, fatty acid esters of glycerol, and hydroxyl apatites.

Oxidising agents as additives can serve to increase the oxidising rate of the phenolics. One example is the enzyme tyrosinase which oxidizes phenols to hydroxyphenols/quinones and therefore accelerates the binder forming reaction.

In another embodiment, the oxidising agent is oxygen, which is supplied to the binder.

In one embodiment, the curing is performed in oxygen-enriched surroundings.

A mineral wool product comprising mineral wool fibres bound by a binder

The present invention is also directed to a mineral wool product bound by a binder resulting from the method according to the present invention described.

In a preferred embodiment, the density of the mineral wool product is in the range of 10-1200 kg/m³, such as 30-800 kg/m³, such as 40-600 kg/m³, such as 50-250 kg/m³, such as 60-200 kg/m³.

In a preferred embodiment, the mineral wool product according to the present invention is an insulation product, in particular having a density of 10 to 200 kg/m³.

In an alternative embodiment, the mineral wool product according to the present invention is a façade panel, in particular having a density of 1000-1200 kg/m³.

In a preferred embodiment, the mineral wool product according to the present invention is an insulation product.

In a preferred embodiment, the loss on ignition (LOI) of the mineral wool product according to the present invention is within the range of 0.1 to 25.0%, such as 0.3 to 18.0%, such as 0.5 to 12.0%, such as 0.7 to 8.0% by weight.

In one embodiment the mineral wool product is a mineral wool insulation product, such as a mineral wool thermal or acoustical insulation product.

In one embodiment the mineral wool product is a horticultural growing media.

Further details on the method of producing a mineral wool product

The present invention provides a method of producing a mineral wool product by binding mineral fibres with the binder composition.

In one embodiment, the binder is supplied in the close vicinity of the fibre forming apparatus, such as a cup spinning apparatus or a cascade spinning apparatus, in either case immediately after the fibre formation. The fibres with applied binder are thereafter conveyed onto a conveyor belt as a web, such as a collected web.

The web, such as a collected web may be subjected to longitudinal or length compression after the fibre formation and before substantial curing has taken place.

Fiber Forming Apparatus

There are various types of centrifugal spinners for fiberizing mineral melts.

A conventional centrifugal spinner is a cascade spinner which comprises a sequence of a top (or first) rotor and a subsequent (or second) rotor and optionally other subsequent rotors (such as third and fourth rotors). Each rotor rotates about a different substantially horizontal axis with a rotational direction opposite to the rotational direction of the or each adjacent rotor in the sequence. The different horizontal axes are arranged such that melt which is poured on to the top rotor is thrown in sequence on to the peripheral surface of the or each subsequent rotor, and fibres are thrown off the or each subsequent rotor, and optionally also off the top rotor.

In one embodiment, a cascade spinner or other spinner is arranged to fiberize the melt and the fibres are entrained in air as a cloud of the fibres.

Many fiber forming apparatuses comprise a disc or cup that spins around a substantially vertical axis. It is then conventional to arrange several of these spinners in-line, i.e. substantially in the first direction, for instance as described in GB-A-926,749, U.S. Pat. No. 3,824,086 and WO-A-83/03092.

There is usually a stream of air associated with the one or each fiberizing rotor whereby the fibres are entrained in this air as they are formed off the surface of the rotor.

In one embodiment, binder and/or additives is added to the cloud of fibres by known means. The amount of binder and/or additive may be the same for each spinner or it may be different.

In one embodiment, a hydrocarbon oil may be added into the cloud of fibres.

As used herein, the term “collected web” is intended to include any mineral fibres that have been collected together on a surface, i.e. they are no longer entrained in air, e.g. the fiberized mineral fibres, granulate, tufts or recycled web waste. The collected web could be a primary web that has been formed by collection of fibres on a conveyor belt and provided as a starting material without having been cross-lapped or otherwise consolidated.

Alternatively, the collected web could be a secondary web that has been formed by crosslapping or otherwise consolidating a primary web. Preferably, the collected web is a primary web.

In one embodiment the mixing of the binder with the mineral fibres is done after the provision of the collected web in the following steps:
subjecting the collected web of mineral fibres to a disentanglement process,
suspending the mineral fibres in a primary air flow,
mixing binder composition with the mineral fibres before, during or after the disentanglement process to form a mixture of mineral fibres and binder.

A method of producing a mineral wool product comprising the process step of disentanglement is described in EP10190521, which is incorporated by reference.

In one embodiment, the disentanglement process comprises feeding the collected web of mineral fibres from a duct with a lower relative air flow to a duct with a higher relative air flow. In this embodiment, the disentanglement is believed to occur, because the fibres that enter the duct with the higher relative air flow first are dragged away from the subsequent fibres in the web. This type of disentanglement is particularly effective for producing open tufts of fibres, rather than the compacted lumps that can result in an uneven distribution of materials in the product.

According to a particularly preferred embodiment, the disentanglement process comprises feeding the collected web to at least one roller which rotates about its longitudinal axis and has spikes protruding from its circumferential surface. In this embodiment, the rotating roller will usually also contribute at least in part to the higher relative air flow. Often, rotation of the roller is the sole source of the higher relative air flow.

In preferred embodiments, the mineral fibres and optionally the binder are fed to the roller from above. It is also preferred for the disentangled mineral fibres and optionally the binder to be thrown away from the roller laterally from the lower part of its circumference. In the most preferred embodiment, the mineral fibres are carried approximately 180 degrees by the roller before being thrown off.

The binder may be mixed with the mineral fibres before, during or after the disentanglement process. In some embodiments, it is preferred to mix the binder with the fibres prior to the disentanglement process. In particular, the fibres can be in the form of an uncured collected web containing binder.

It is also feasible that the binder be pre-mixed with a collected web of mineral fibres before the disentanglement process. Further mixing could occur during and after the disentanglement process. Alternatively, it could be supplied to the primary air flow separately and mixed in the primary air flow.

The mixture of mineral fibres and binder is collected from the primary air flow by any suitable means. In one embodiment, the primary air flow is directed into the top of a cyclone chamber, which is open at its lower end and the mixture is collected from the lower end of the cyclone chamber.

The mixture of mineral fibres and binder is preferably thrown from the disentanglement process into a forming chamber.

Having undergone the disentanglement process, the mixture of mineral fibres and binder is collected, pressed and cured. Preferably, the mixture is collected on a foraminous conveyor belt having suction means positioned below it.

In a preferred method according to the invention, the mixture of binder and mineral fibres, having been collected, is pressed and cured.

In a preferred method according to the invention, the mixture of binder and mineral fibres, having been collected, is scalped before being pressed and cured.

The method may be performed as a batch process, however according to an embodiment the method is performed at a mineral wool production line feeding a primary or secondary mineral wool web into the fibre separating process, which provides a particularly cost efficient and versatile method to provide composites having favourable mechanical properties and thermal insulation properties in a wide range of densities.

Further Details on the Curing Step

The web is cured by a chemical and/or physical reaction of the binder components.

In one embodiment, the curing takes place in a curing device.

In one embodiment the curing is carried out at temperatures from 150° C.-250° C., such as >150° C.-250° C., such as 175° C.-225° C., such as up to 220° C., such as up to 215° C.

The curing process may commence immediately after application of the binder to the fibres.

In one embodiment the curing process comprises cross-linking and/or water inclusion as crystal water.

In one embodiment the cured binder contains crystal water that may decrease in content and raise in content depending on the prevailing conditions of temperature, pressure and humidity.

In one embodiment the curing takes place in a conventional curing oven for mineral wool production operating at a temperature of from 150° C.-250° C., such as >150° C.-250° C., such as 175° C.-225° C., such as up to 220° C., such as up to 215° C.

In one embodiment the curing process comprises a drying process.

In a preferred embodiment, the curing of the binder in contact with the mineral fibers takes place in a heat press.

The curing of a binder in contact with the mineral fibers in a heat press has the particular advantage that it enables the production of high-density products.

In one embodiment the curing process comprises drying by pressure.

The pressure may be applied by blowing air or gas to the mixture of mineral fibres and binder. The blowing process may be accompanied by heating or cooling or it may be at ambient temperature.

In one embodiment the curing process takes place in a humid environment.

The humid environment may have a relative humidity RH of 60-99%, such as 70-95%, such as 80-92%. The curing in a humid environment may be followed by curing or drying to obtain a state of the prevalent humidity.

The mineral wool product can be in any conventional configuration, for instance a mat or slab, and can be cut and/or shaped (e.g. into pipe sections) before, during or after curing of the binder.

Binder for Mineral Wool

The present invention is also directed to a binder composition for mineral fibres having the features as described above.

### EXAMPLES

### Examples A—Laboratory Examples

In the following examples, several binders which fall under the definition of the present invention were prepared and compared to binders according to the prior art.

Experimental Methods and Definitions

General Experimental Methods

IMAGEL® LA gelatine (Type A, porcine, 120 bloom), IMAGEL® RA (Type A, porcine, 180 bloom) and IMAGEL® LB gelatine (Type B, porcine, 122 bloom) were obtained from GELITA AG. Fish gelatine powder (250 bloom) was obtained from Modernist Pantry. Glustar 100 wheat protein and Hemp Yeah hemp protein powder were obtained from KrOner-Starke and Manitoba Harvest, respectively. Calcium hydroxide was obtained from Alfa Aesar. Citric acid monohydrate was obtained from VWR Life Science. Quebracho Extract Indusol ATO tannin (sulfonated quebracho tannin) was obtained from Otto Dille. Chestnut tree tannin (Vinoferm Tannorouge, food grade) was obtained from Brouwland bvba. Quebracho tannin (Tannivin® Structure, high proanthocyanidin content) was obtained from ErbslOh. Leiria Firnis linseed oil was obtained from OLI-NATURA. Linseed oil (virgin grade, cold pressed) was obtained from Borup Kemi. Coconut oil (virgin grade, cold pressed) was obtained from COOP. 75% aq. glucose syrup with a DE-value of 95 to less than 100 (C*sweet D 02767 ex Cargill) was supplied by Cargill. Silane (Momentive VS-142) was supplied by Momentive. Soybean flour Type 1, tannic acid, sodium hydroxide, 50% aq. hypophosphorous acid, 28% aq. ammonia and all other components were obtained in high purity from Sigma-Aldrich. All components for which a concentration is not detailed above were assumed completely pure and anhydrous for simplicity.

Measurements of pH were performed using a Mettler Toledo SevenCompact™ S220 pH meter equipped with a Mettler Toledo InLab® Expert Pro-ISM pH electrode and temperature probe.

Crude stone shots (predominantly rounded particles which have the same melt composition as the stone wool fibers) formed during the cascade spinning process of a stone melt in the production of stone wool fibers were obtained from a ROCKWOOL® factory in the Netherlands. Cleaned and sifted stone shots appropriate for the manufacture of composite bars were produced from these crude stone shots by ProChem GmbH, Germany. In brief, the stone shots were heat treated overnight at 590° C. to remove any trace organics. After cooling, the stone shots were sifted through 0.50 mm and 0.25 mm sieves. The coarse and fine fractions were discarded, and the remaining stone shots were washed thoroughly several times in demineralized water. The sifted and cleaned stone shots were dried and where then stored in a closed bag until use.

FUNKTION heat resistant silicone forms for manufacture of bars (4×5 slots per form; slot top dimension: length=5.6 cm, width=2.5 cm; slot bottom dimension: length=5.3 cm, width=2.2 cm; slot height=1.1 cm) were obtained from F&H of Scandinavia A/S.

Three-point bending tests were recorded on a Bent Tram SUT 3000/520 test machine (test speed: 10.0 mm/min; rupture level: 50 N; nominal strength: 30 N/mm2; support distance: 40 mm; max deflection 20 mm; nominal E-modulus 10000 N/mm2). The bars were placed with the “top face” up (i.e. the face with the dimensions length=5.6 cm, width=2.5 cm) in the machine.

New tin foil containers for use in measurement of binder solids (reference binders A and B only) and of loss of ignition of composite bars were heat-treated at 590° C. for 15 minutes prior to use to remove all organics.

An open-end, heated tube oven apparatus (Nabertherm) was used for the generation of binder curing emissions. The emissions generated from binder samples placed within the tube oven at a given temperature were measured by drawing a constant flow of air across the sample through heated tubes to a Gasmet DX4000 FTIR gas analyzer. CALMET software (version 12.18) was used to analyze the emissions.

Binder Component Solids Content—Definition

The content of each of the components in a given binder solution before curing is based on the anhydrous mass of the components. The following formula can be used:

$$Binder component solids content ( \% ) = \frac{\begin{matrix}binder component A solids ( g ) + \\ binder component B solids ( g ) + …\end{matrix}}{total weight of mixture ( g )} \times 100 \%$$

Binder Solids—Definition and Procedure (Only Reference Binders A and B)

The content of binder after curing is termed “binder solids”.

Disc-shaped stone wool samples (diameter: 5 cm; height 1 cm) were cut out of stone wool and heat-treated at 590° C. for at least 30 minutes to remove all organics. The solids of the binder mixture (see below for mixing examples) were measured by distributing a sample of the binder mixture (approx. 2 g) onto a heat treated stone wool disc in a tin foil container. The tin foil container containing the stone wool disc was weighed before and directly after addition of the binder mixture. Two such binder mixture loaded stone wool discs in tin foil containers were produced and they were then heated at 200° C. for 1 hour. After cooling and storing at room temperature for 10 minutes, the samples were weighed and the binder solids were calculated as an average of the two results.

Reaction Loss—Definition

The reaction loss is defined as the difference between the binder component solids content and the binder solids, obtained by the methods detailed above. For all binders except reference binders A and B, the reaction loss was obtained as the difference in the loss of ignition (LOI) of composite bars produced at room temperature and the LOI of the corresponding composite bars produced at 150-225° C.

Manufacture of Composite Bars (Only Reference Binders A and B)

A 15% binder solids solution was obtained as described in the examples below. A sample of the binder solution (17.8 g) was mixed well with shots (100.0 g). The resulting mixture was then filled into four slots in a heat resistant silicone form for making bars. During the manufacture of each composite bar, the mixtures placed in the slots were pressed as required and then evened out with a plastic spatula to generate an even bar surface. In general, 32 bars were made in this fashion from each binder composition. The production of a surplus of bars allowed for discarding bars during the various treatment processes due to the presence of visual irregularities such as uneven surfaces, cracks and/or air pockets created during the manufacturing process. Bars made using reference binder A were cured for 1 h at 200° C. while bars made using reference binder B were cured for 1 h at 225° C.

Manufacture of Composite Bars (Binders According to the Present Invention as Well as all Other Reference Binders)

A 20%-wt. binder mixture was obtained as described in the examples below. A sample of the binder mixture (61.3 g) was added to shots (460.0 g) preheated to 50° C. in a mixing bowl, likewise heated to 50° C. The resulting mixture was then mixed for approx. 2-5 minutes using a mixing machine while still heating the mixing bowl to 50° C. The resulting mixture was then filled into 16 slots in a heat resistant silicone form for making bars. During the manufacture of each composite bar, the mixtures placed in the slots were pressed as required and then evened out with a plastic spatula to generate an even bar surface. In general, 16-32 bars were made in this fashion from each binder composition. The production of a surplus of bars allowed for discarding bars during the various treatment processes due to the presence of visual irregularities such as uneven surfaces, cracks and/or air pockets created during the manufacturing process. The bars were cured either at 150-225° C. for 1 h or at room temperature for 2-3 days. The bars cured at room temperature were carefully taken out of the containers after the initial curing period, turned upside down and left for 1-2 days further at room temperature to cure and dry completely.

Ageing Treatment of Composite Bars

Ageing treatment of composite bars was performed by subjecting the bars to autoclave treatment (15 min/120° C./1.2 bar) or water bath treatment (3 h/80° C.) followed by cooling to room temperature and drying for 2-3 days.

Measurement of Mechanical Strengths of Composite Bars

The maximum load force required to break composite bars was recorded in a three-point bending test. For each data point, an average value was calculated on the basis of four to eight bars that had been subjected to identical treatment.

Measurement of Loss of Ignition (LOT) of Composite Bars

The loss of ignition (LOI) of the composite bars was measured in small tin foil containers by treatment at 590° C. The tin foil container was weighed and four bars (usually after being broken in the three-point bending test) were placed into the tin foil container. The ensemble was weighed and was then heat-treated at 590° C. for 30 minutes. After cooling to room temperature, the weight was recorded again and the loss of ignition (LOI) was calculated using the following formula:

$$LOI ( \% ) = \frac{\begin{matrix}Weight of bars before heat treatment ( g ) - \\ Weight of bars after heat treatment ( g )\end{matrix}}{Weight of bars before heat treatment ( g )} \times 100 \%$$

Binder Solubility—Definition

The binder solubility is defined as the difference in the loss of ignition (LOI) of composite bars after ageing compared to the LOI of the composite bars before ageing.

Water Absorption Measurements

The water absorption of the binders was measured by weighing three bars and then submerging the bars in water (approx. 250 mL) in a beaker (565 mL, bottom Ø=9.5 cm; top Ø=10.5 cm; height=7.5 cm) for 3 h or 24 h. The bars were placed next to each other on the bottom of the beaker with the “top face” down (i.e. the face with the dimensions length=5.6 cm, width=2.5 cm). After the designated amount of time, the bars were lifted up one by one and allowed to drip off for one minute. The bars were held (gently) with the length side almost vertical so that the droplets would drip from a corner of the bar. The bars were then weighed and the water absorption was calculated using the following formula:

$$Water abs . ( \% ) = \frac{\begin{matrix}Weight of bars after water treatment ( g ) - \\ Weight of bars before water treatment ( g )\end{matrix}}{Weight of bars before water treatment ( g )} \times 100 \%$$

Measurements of Ammonia Emissions During Curing

A 15% binder component solids content binder solution was obtained in an analogous manner to the procedures described in the examples below. Immediately prior to commencing each emission measurement, 1.5 g of the binder solution was distributed evenly on binder-free stone wool samples in a small ceramic crucible. Background ammonia emissions were obtained by starting the emission measurements in the pre-heated tube oven a few minutes before inserting the sample. The sample was then loaded into the tube oven and a temperature probe was inserted close to the sample to measure the actual curing temperature. The ammonia emissions were then recorded with a 30 second sample frequency during a period of 10 minutes. Three such 10 minutes emission recordings were made in this fashion for each binder composition. The recorded individual ammonia emission measurements were then accumulated and averaged for each binder composition. The results are given in Table 1-12 as relative ammonia emission indexes compared to the binder composition that produced the highest ammonia emissions (index 100).

Reference binder compositions from the prior art and reference binders

### Reference Binder, Example a (Phenol-Formaldehyde Resin Modified with Urea, a PUF-Resol)

A phenol-formaldehyde resin is prepared by reacting 37% aq. formaldehyde (606 g) and phenol (189 g) in the presence of 46% aq. potassium hydroxide (25.5 g) at a reaction temperature of 84° C. preceded by a heating rate of approximately 1° C. per minute. The reaction is continued at 84° C. until the acid tolerance of the resin is 4 and most of the phenol is converted. Urea (241 g) is then added and the mixture is cooled.

The acid tolerance (AT) expresses the number of times a given volume of a binder can be diluted with acid without the mixture becoming cloudy (the binder precipitates). Sulfuric acid is used to determine the stop criterion in a binder production and an acid tolerance lower than 4 indicates the end of the binder reaction. To measure the AT, a titrant is produced from diluting 2.5 mL conc. sulfuric acid (>99%) with 1 L ion exchanged water. 5 mL of the binder to be investigated is then titrated at room temperature with this titrant while keeping the binder in motion by manually shaking it; if preferred, use a magnetic stirrer and a magnetic stick. Titration is continued until a slight cloud appears in the binder, which does not disappear when the binder is shaken.

The acid tolerance (AT) is calculated by dividing the amount of acid used for the titration (mL) with the amount of sample (mL):

AT=(Used titration volume (mL))/(Sample volume (mL))

Using the urea-modified phenol-formaldehyde resin obtained, a binder is made by addition of 25% aq. ammonia (90 mL) and ammonium sulfate (13.2 g) followed by water (1.30 kg). The binder solids were then measured as described above and the mixture was diluted with the required amount of water and silane (Momentive VS-142) for mechanical strength studies (15% binder solids solution, 0.5% silane of binder solids).

### Reference Binder, Example B

A mixture of 75% aq. glucose syrup (38.9 g), ammonium sulfamate (1.17 g), 50% hypophosphorous acid (0.58 g) and urea (1.46 g) in water (106.4 g) was stirred at room temperature until a clear solution was obtained. 28% aq. ammonia (0.38 g) was then added dropwise followed by 10% silane Momentive VS-142 silane (1.13 g). The final binder mixture was 15% in binder solids and had pH 8.

### Reference Binder, Examples C and D

Binder compositions C and D were mixed in the appropriate ingredient percentages as detailed in WO2010/132641 and Table 1-1 to provide 20% binder solids component mixtures. The resulting mixtures were then used in the subsequent experiments.

Binder compositions according to the present invention

### Binder Example, Example 2

To 0.5 M NaOH (38.5 g) stirred at room temperature was added Quebracho Extract Indusol ATO tannin (11.0 g). After stirring at room temperature for 5-10 min further, the resulting deep-brown solution (pH 9.0) was used in the subsequent experiments.

A mixture of IMAGEL® LA gelatin (24.0 g) in water (90.0 g) was stirred at 50° C. for approx. 15-30 min until a clear solution was obtained (pH 5.1). Leinol Firnis linseed oil (1.26 g) followed by a portion of the above Quebracho Extract Indusol ATO tannin solution (5.40 g; thus efficiently 1.20 g tannin) and 4.0% silane (1.26 g, thus efficiently 0.05 g silane) were then added (pH 5.9). 1M NaOH (2.58 g) was then added followed by water (8.96 g). After stirring for 1-2 minutes further at 50° C., the resulting brown mixture (pH 7.3) was used in the subsequent experiments.

### Binder Example, Example 6

To 0.5 M NaOH (38.5 g) stirred at room temperature was added Quebracho Extract Indusol ATO tannin (11.0 g). After stirring at room temperature for 5-10 min further, the resulting deep-brown solution (pH 9.0) was used in the subsequent experiments.

A mixture of fish gelatine powder (24.0 g) in water (90.0 g) was stirred at 50° C. for approx. 15-30 min until a clear solution was obtained (pH 5.7). Leind Firnis linseed oil (1.26 g) followed by a portion of the above Quebracho Extract Indusol ATO tannin solution (5.40 g; thus efficiently 1.20 g tannin) and 4.0% silane (1.26 g, thus efficiently 0.05 g silane) were then added (pH 7.6). Water (11.0 g) was then added. After stirring for 1-2 minutes further at 50° C., the resulting brown mixture (pH 7.6) was used in the subsequent experiments.

### Binder Example, Example 9

To 0.5 M NaOH (38.5 g) stirred at room temperature was added Tannivin® Structure quebracho tannin (11.0 g). After stirring at room temperature for 5-10 min further, the resulting deep-brown solution (pH 9.1) was used in the subsequent experiments.

A mixture of IMAGEL® LA gelatin (24.0 g) in water (90.0 g) was stirred at 50° C. for approx. 15-30 min until a clear solution was obtained (pH 5.0). Leind Firnis linseed oil (1.26 g) followed by a portion of the above Tannivin® Structure quebracho tannin solution (5.40 g; thus efficiently 1.20 g tannin) and 4.0% silane (1.26 g, thus efficiently 0.05 g silane) were then added (pH 5.7). 1M NaOH (2.92 g) was then added followed by water (8.69 g). After stirring for 1-2 minutes further at 50° C., the resulting brown mixture (pH 7.2) was used in the subsequent experiments.

### Binder Example, Example 13

To 0.15 M NaOH (38.5 g) stirred at room temperature was added Quebracho Extract Indusol ATO tannin (11.0 g). After stirring at room temperature for 5-10 min further, the resulting deep-brown solution (pH 8.2) was used in the subsequent experiments.

A mixture of IMAGEL® LA gelatin (20.0 g) in water (85.0 g) was stirred at 50° C. for approx. 15-30 min until a clear solution was obtained (pH 5.1). Leind Firnis linseed oil (1.07 g) followed by a portion of the above Quebracho Extract Indusol ATO tannin solution (31.5 g; thus efficiently 7.00 g tannin) and 4.0% silane (1.35 g, thus efficiently 0.05 g silane) were then added (pH 6.7). 1M NaOH (2.01 g) was then added followed by water (21.1 g). After stirring for 1-2 minutes further at 50° C., the resulting brown mixture (pH 7.5) was used in the subsequent experiments.

### Binder Example, Example 15

To 0.5 M NaOH (38.5 g) stirred at room temperature was added Quebracho Extract Indusol ATO tannin (11.0 g). After stirring at room temperature for 5-10 min further, the resulting deep-brown solution (pH 9.0) was used in the subsequent experiments.

A mixture of IMAGEL® LA gelatin (24.0 g) in water (90.0 g) was stirred at 50° C. for approx. 15-30 min until a clear solution was obtained (pH 5.1). Coconut oil (1.26 g) followed by a portion of the above Quebracho Extract Indusol ATO tannin solution (5.40 g; thus efficiently 1.20 g tannin) and 4.0% silane (1.26 g, thus efficiently 0.05 g silane) were then added (pH 5.8). 1M NaOH (2.69 g) was then added followed by water (8.87 g). After stirring for 1-2 minutes further at 50° C., the resulting brown mixture (pH 7.3) was used in the subsequent experiments.

### Binder Example, Example 18

To 0.5 M NaOH (38.5 g) stirred at room temperature was added Quebracho Extract Indusol ATO tannin (11.0 g). After stirring at room temperature for 5-10 min further, the resulting deep-brown solution (pH 9.0) was used in the subsequent experiments.

A mixture of IMAGEL® LA gelatin (22.0 g) in water (90.0 g) was stirred at 50° C. for approx. 15-30 min until a clear solution was obtained (pH 5.1). Leinol Firnis linseed oil (4.62 g) followed by a portion of the above Quebracho Extract Indusol ATO tannin solution (4.95 g; thus efficiently 1.10 g tannin) and 4.0% silane (1.16 g, thus efficiently 0.05 g silane) were then added (pH 5.9). 1M NaOH (2.59 g) was then added followed by water (14.4 g). After stirring for 1-2 minutes further at 50° C., the resulting brown mixture (pH 7.3) was used in the subsequent experiments.

### Binder Example, Example 20

To water (38.5 g) stirred at room temperature was added Quebracho Extract Indusol ATO tannin (11.0 g). After stirring at room temperature for 5-10 min further, the resulting deep-brown solution (pH 5.2) was used in the subsequent experiments.

A mixture of IMAGEL® LA gelatin (24.0 g) in water (90.0 g) was stirred at 50° C. for approx. 15-30 min until a clear solution was obtained (pH 5.2). Leinol Firnis linseed oil (1.26 g) followed by a portion of the above Quebracho Extract Indusol ATO tannin solution (5.40 g; thus efficiently 1.20 g tannin) and 4.0% silane (1.26 g, thus efficiently 0.05 g silane) were then added (pH 5.1). Water (10.6 g) was then added. After stirring for 1-2 minutes further at 50° C., the resulting brown mixture (pH 5.1) was used in the subsequent experiments.

### Binder Example, Example 21

To 0.5 M NaOH (38.5 g) stirred at room temperature was added Quebracho Extract Indusol ATO tannin (11.0 g). After stirring at room temperature for 5-10 min further, the resulting deep-brown solution (pH 9.0) was used in the subsequent experiments.

A mixture of IMAGEL® LA gelatin (24.0 g) in water (90.0 g) was stirred at 50° C. for approx. 15-30 min until a clear solution was obtained (pH 5.1). Leinol Firnis linseed oil (1.26 g) followed by a portion of the above Quebracho Extract Indusol ATO tannin solution (5.40 g; thus efficiently 1.20 g tannin) and 4.0% silane (1.26 g, thus efficiently 0.05 g silane) were then added (pH 5.8). 1M NaOH (8.57 g) was then added followed by water (4.12 g). After stirring for 1-2 minutes further at 50° C., the resulting brown mixture (pH 9.0) was used in the subsequent experiments.

### Binder Example, Example 22

To water (200 mL) stirred at room temperature was added Ca(OH)₂ (3.70 g). After stirring at room temperature for 5-10 min further, the resulting colorless suspension was used in the subsequent experiments (while kept under continuous stirring).

To a portion of the above Ca(OH)₂ mixture (38.5 g) stirred at room temperature was added Quebracho Extract Indusol ATO tannin (11.0 g). After stirring at room temperature for 5-10 min further, the resulting deep-brown mixture (pH 8.7) was used in the subsequent experiments.

A mixture of IMAGEL® LA gelatin (24.0 g) in water (90.0 g) was stirred at 50° C. for approx. 15-30 min until a clear solution was obtained (pH 5.1). Leind Firnis linseed oil (1.26 g) followed by a portion of the above Quebracho Extract Indusol ATO tannin mixture (5.40 g; thus efficiently 1.20 g tannin) and 4.0% silane (1.26 g, thus efficiently 0.05 g silane) were then added (pH 5.8). A portion of the above Ca(OH)₂ mixture (6.44 g) was then added followed by water (5.16 g). After stirring for 1-2 minutes further at 50° C., the resulting brown mixture (pH 7.2) was used in the subsequent experiments.

### Binder Example, Example 23

To 0.5 M NaOH (38.5 g) stirred at room temperature was added Quebracho Extract Indusol ATO tannin (11.0 g). After stirring at room temperature for 5-10 min further, the resulting deep-brown solution (pH 9.0) was used in the subsequent experiments.

A mixture of IMAGEL® LA gelatin (24.0 g) in water (90.0 g) was stirred at 50° C. for approx. 15-30 min until a clear solution was obtained (pH 5.1). Leind Firnis linseed oil (1.26 g) followed by a portion of the above Quebracho Extract Indusol ATO tannin solution (5.40 g; thus efficiently 1.20 g tannin) were then added (pH 5.7). 1M NaOH (3.42 g) was then added followed by water (9.29 g). After stirring for 1-2 minutes further at 50° C., the resulting brown mixture (pH 7.5) was used in the subsequent experiments.

### Binder Example, Example 24

To 0.5 M NaOH (38.5 g) stirred at room temperature was added Quebracho Extract Indusol ATO tannin (11.0 g). After stirring at room temperature for 5-10 min further, the resulting deep-brown solution (pH 9.0) was used in the subsequent experiments.

A mixture of IMAGEL® LA gelatin (21.0 g) and Glustar 100 wheat protein (7.0 g) in water (100.0 g) was stirred at 50° C. for approx. 15-30 min until a homogeneous suspension was obtained (pH 5.1). Leind Firnis linseed oil (1.47 g) followed by a portion of the above Quebracho Extract Indusol ATO tannin solution (6.30 g; thus efficiently 1.40 g tannin) and 4.0% silane (1.47 g, thus efficiently 0.06 g silane) were then added (pH 6.0). 1M NaOH (2.49 g) was then added followed by water (15.9 g). After stirring for 1-2 minutes further at 50° C., the resulting brown mixture (pH 7.3) was used in the subsequent experiments.

### Binder Example, Example 26

To 0.5 M NaOH (38.5 g) stirred at room temperature was added Quebracho Extract Indusol ATO tannin (11.0 g). After stirring at room temperature for 5-10 min further, the resulting deep-brown solution (pH 9.0) was used in the subsequent experiments.

A mixture of IMAGEL® LA gelatin (22.5 g) and Hemp Yeah hemp protein powder (7.50 g) in water (100.0 g) was stirred at 50° C. for approx. 15-30 min until a homogeneous suspension was obtained (pH 5.3). A portion of the above Quebracho Extract Indusol ATO tannin solution (6.75 g; thus efficiently 1.50 g tannin) and 4.0% silane (1.58 g, thus efficiently 0.06 g silane) were then added (pH 5.9). 1M NaOH (3.74 g) was then added followed by water (17.0 g). After stirring for 1-2 minutes further at 50° C., the resulting brown mixture (pH 7.2) was used in the subsequent experiments.

TABLE 1-1
Binder compositions according to the prior art

| Example | A | B | C | D |
|---|---|---|---|---|
| Binder composition | | | | |
| Components ^{[a]} | | | | |
| Soybean flour | — | — | 96.7 | 70.4 |
| Citric acid | — | — | — | 23.5 |
| Tannic acid | — | — | — | 5.9 |
| Sodium hydroxide | — | — | 3 | — |
| Additive ^{[b]} | | | | |
| Silane | 0.2 | 0.2 | 0.2 | 0.2 |
| Binder mixing and bar | | | | |
| manufacture | | | | |
| Binder solids (%) | 15.0 | 15.0 | — | — |
| Binder component solids | — | — | 20.0 | 20.0 |
| content (%) | | | | |
| pH of binder mixture | 9.6 | 8 | 10.5 | 2.9 |
| Curing temperature (° C.) | 200 | 225 | 175 | 175 |
| Bar properties | | | | |
| Mechanical strength, | 0.41 | 0.39 | 0.17 | 0.00 |
| unaged (kN) | | | | |
| Mechanical strength, | 0.15 | 0.16 | 0.12 | 0.01 |
| AC aged (kN) | | | | |
| Mechanical strength, | 0.17 | 0.12 | 0.07 | 0.00 |
| WB aged (kN) | | | | |
| LOI, unaged (%) | 2.6 | 2.4 | 2.2 | 2.3 |
| LOI, autoclave aged (%) | 2.7 | 2.6 | 2.3 | 2.4 |
| LOI, water bath aged (%) | 2.6 | 2.4 | 1.5 | 1.6 |
| Reaction loss (%) | 28.5 | 30.3 | 4 | 8 |
| Binder solubility (%) | — | — | 32 | 32 |
| Bar weight (g per bar) | 24.7 | 24.3 | 25.4 | 22.9 |
| Water absorption, 3 h (%) | 6 | 23 | 22 | — ^{[c]} |
| Water absorption, 24 h (%) | 16 | 24 | 23 | — ^{[c]} |

^{[a]} Ingredient percentage.
^{[b]} Of binder solids or binder components solids content.
^{[c]} Disintegrates during measurement.
″rt″ denotes room temperature, in all Tables.

TABLE 1-2
Curing temperature study

| Example | 1 | 2 | 3 | 4 | 2rt |
|---|---|---|---|---|---|
| Binder composition | | | | | |
| Protein (%-wt.) ^{[a]} | | | | | |
| IMAGEL ® LA gelatin | 100 | 100 | 100 | 100 | 100 |
| (A, 120 bloom) | | | | | |
| IMAGEL ® RA gelatin | — | — | — | — | — |
| (A, 180 bloom) | | | | | |
| IMAGEL ® LB gelatin | — | — | — | — | |
| (B, 122 bloom) | | | | | |
| Fish gelatin powder | — | — | — | — | — |
| (250 bloom) | | | | | |
| Glustar 100 wheat protein | — | — | — | — | — |
| Hemp protein | — | — | — | — | — |
| Crosslinker (%-wt.) ^{[a]} | | | | | |
| Quebracho Idusol ATO | 5 | 5 | 5 | 5 | 5 |
| (sulfonated) | | | | | |
| Quebracho tannin | — | — | — | — | — |
| (condensed) | | | | | |
| Chestnut tree tannin | — | — | — | — | — |
| (hydrolysable) | | | | | |
| Fatty acid ester of | | | | | |
| glycerol ^{[b]} | | | | | |
| Linseed oil (Leinöl Firnis) | 5 | 5 | 5 | 5 | 5 |
| Linseed oil (Borup Jomfru) | — | — | — | — | — |
| Coconut oil | — | — | — | — | — |
| Base (%-wt.) ^{[b]} | | | | | |
| Sodium hydroxide | 0.74 | 0.72 | 0.77 | 0.83 | 0.72 |
| Calcium hydroxide | — | — | — | — | — |
| Additive ^{[b]} | | | | | |
| Silane | 0.2 | 0.2 | 0.2 | 0.2 | 0.2 |
| Binder mixing and bar | | | | | |
| manufacture | | | | | |
| Binder component solids | 20.0 | 20.0 | 20.0 | 20.0 | 20.0 |
| content (%) | | | | | |
| pH of binder mixture | 7.3 | 7.3 | 7.4 | 7.5 | 7.3 |
| Curing temperature (° C.) | 150 | 175 | 200 | 225 | rt |
| Bar properties | | | | | |
| Mechanical strength, | 0.68 | 0.71 | 0.67 | 0.30 | 0.65 |
| unaged (kN) | | | | | |
| Mechanical strength, | 0.62 | 0.69 | 0.60 | 0.14 | 0.65 |
| AC aged (kN) | | | | | |
| Mechanical strength, | 0.06 | 0.20 | 0.34 | 0.05 | 0.45 |
| WB aged (kN) | | | | | |
| LOI, unaged (%) | 2.4 | 2.4 | 2.3 | 2.2 | 2.6 |
| LOI, autoclave aged (%) | 2.5 | 2.5 | 2.5 | 2.4 | 2.6 |
| LOI, water bath aged (%) | 1.0 | 1.3 | 1.9 | 1.6 | 2.2 |
| Reaction loss (%) | 7 | 8 | 10 | 13 | — |
| Binder solubility (%) | 57 | 44 | 19 | 28 | 15 |
| Bar weight (g per bar) | 26.1 | 26.0 | 26.2 | 25.6 | 26.3 |
| Water absorption, 3 h (%) | 22 | 17 | 11 | 14 | 4 |
| Water absorption, 24 h (%) | 25 | 23 | 17 | 19 | 9 |

^{[a]} Of protein.
^{[b]} Of protein + crosslinker.

TABLE 1-3
Gelatin study

| Example | 2 | 2rt | 5 | 5rt | 6 | 6rt | 7 | 7rt |
|---|---|---|---|---|---|---|---|---|
| Binder composition | | | | | | | | |
| Protein (%-wt.) ^{[a]} | | | | | | | | |
| IMAGEL ® LA gelatin (A, 120 bloom) | 100 | 100 | — | — | — | — | — | — |
| IMAGEL ® RA gelatin (A, 180 bloom) | — | — | 100 | 100 | — | — | — | — |
| IMAGEL ® LB gelatin (B, 122 bloom) | — | — | — | — | — | — | 100 | 100 |
| Fish gelatin (250 bloom) | — | — | — | — | 100 | 100 | — | — |
| Glustar 100 wheat protein | — | — | — | — | — | — | — | — |
| Hemp protein | — | — | — | — | — | — | — | — |
| Crosslinker (%-wt.) ^{[a]} | | | | | | | | |
| Quebracho Idusol ATO (sulfonated) | 5 | 5 | 5 | 5 | 5 | 5 | 5 | 5 |
| Quebracho tannin (condensed) | — | — | — | — | — | — | — | — |
| Chestnut tree tannin (hydrolysable) | — | — | — | — | — | — | — | — |
| Fatty acid ester of glycerol ^{[b]} | | | | | | | | |
| Linseed oil (Leinöl Firnis) | 5 | 5 | 5 | 5 | 5 | 5 | 5 | 5 |
| Linseed oil (Borup Jomfru) | — | — | — | — | — | — | — | — |
| Coconut oil | — | — | — | — | — | — | — | — |
| Base (%-wt.) ^{[b]} | | | | | | | | |
| Sodium hydroxide | 0.72 | 0.72 | 0.62 | 0.62 | 0.33 | 0.33 | 0.75 | 0.75 |
| Calcium hydroxide | — | — | — | — | — | — | — | — |
| Additive ^{[b]} | | | | | | | | |
| Silane | 0.2 | 0.2 | 0.2 | 0.2 | 0.2 | 0.2 | 0.2 | 0.2 |
| Binder mixing and bar manufacture | | | | | | | | |
| Binder component solids content (%) | 20.0 | 20.0 | 20.0 | 20.0 | 20.0 | 20.0 | 20.0 | 20.0 |
| pH of binder mixture | 7.3 | 7.3 | 7.2 | 7.2 | 7.6 | 7.6 | 7.2 | 7.2 |
| Curing temperature (° C.) | 175 | rt | 175 | rt | 175 | rt | 175 | rt |
| Bar properties | | | | | | | | |
| Mechanical strength, unaged (kN) | 0.71 | 0.65 | 0.81 | 0.69 | 0.84 | 0.82 | 0.80 | 0.70 |
| Mechanical strength, AC aged (kN) | 0.69 | 0.65 | 0.75 | 0.71 | 0.62 | 0.82 | 0.70 | 0.79 |
| Mechanical strength, WB aged (kN) | 0.20 | 0.45 | 0.38 | 0.56 | 0.39 | 0.84 | 0.22 | 0.42 |
| LOI, unaged (%) | 2.4 | 2.6 | 2.4 | 2.5 | 2.5 | 2.6 | 2.4 | 2.6 |
| LOI, autoclave aged (%) | 2.5 | 2.6 | 2.5 | 2.5 | 2.6 | 2.6 | 2.5 | 2.6 |
| LOI, water bath aged (%) | 1.3 | 2.2 | 1.9 | 2.3 | 2.2 | 2.5 | 1.7 | 2.3 |
| Reaction loss (%) | 8 | — | 6 | — | 5 | — | 7 | — |
| Binder solubility (%) | 44 | 15 | 18 | 10 | 9 | 5 | 29 | 11 |
| Bar weight (g per bar) | 26.0 | 26.3 | 26.9 | 26.6 | 26.5 | 27.0 | 26.8 | 26.8 |
| Water absorption, 3 h (%) | 17 | 4 | 14 | 3 | 10 | 4 | 20 | 8 |
| Water absorption, 24 h (%) | 23 | 9 | 20 | 8 | 33 | 9 | 31 | 14 |

^{[a]} Of protein.
^{[b]} Of protein + crosslinker.

TABLE 1-4
Tannin type study

| Example | 2 | 2rt | 8 | 8rt | 9 | 9rt |
|---|---|---|---|---|---|---|
| Binder composition | | | | | | |
| Protein (%-wt.) ^{[a]} | | | | | | |
| IMAGEL ® LA gelatin (A, 120 bloom) | 100 | 100 | 100 | 100 | 100 | 100 |
| IMAGEL ® RA gelatin (A, 180 bloom) | — | — | — | — | — | — |
| IMAGEL ® LB gelatin (B, 122 bloom) | — | — | — | — | — | — |
| Fish gelatin (250 bloom) | — | — | — | — | — | — |
| Glustar 100 wheat protein | — | — | — | — | — | — |
| Hemp protein | — | — | — | — | — | — |
| Crosslinker (%-wt.) ^{[a]} | | | | | | |
| Quebracho Idusol ATO (sulfonated) | 5 | 5 | — | — | — | — |
| Quebracho tannin (condensed) | — | — | — | — | 5 | 5 |
| Chestnut tree tannin (hydrolysable) | — | — | 5 | 5 | — | — |
| Fatty acid ester of glycerol ^{[b]} | | | | | | |
| Linseed oil (Leinöl Firnis) | 5 | 5 | 5 | 5 | 5 | 5 |
| Linseed oil (Borup Jomfru) | — | — | — | — | — | — |
| Coconut oil | — | — | — | — | — | — |
| Base (%-wt.) ^{[b]} | | | | | | |
| Sodium hydroxide | 0.72 | 0.72 | 1.02 | 1.02 | 0.77 | 0.77 |
| Calcium hydroxide | — | — | — | — | — | — |
| Additive ^{[b]} | | | | | | |
| Silane | 0.2 | 0.2 | 0.2 | 0.2 | 0.2 | 0.2 |
| Binder mixing and bar manufacture | | | | | | |
| Binder component solids content (%) | 20.0 | 20.0 | 20.0 | 20.0 | 20.0 | 20.0 |
| pH of binder mixture | 7.3 | 7.3 | 7.2 | 7.2 | 7.2 | 7.2 |
| Curing temperature (° C.) | 175 | rt | 175 | rt | 175 | rt |
| Bar properties | | | | | | |
| Mechanical strength, unaged (kN) | 0.71 | 0.65 | 0.76 | 0.74 | 0.74 | 0.62 |
| Mechanical strength, AC aged (kN) | 0.69 | 0.65 | 0.86 | 0.66 | 0.72 | 0.54 |
| Mechanical strength, WB aged (kN) | 0.20 | 0.45 | 0.45 | 0.49 | 0.37 | 0.43 |
| LOI, unaged (%) | 2.4 | 2.6 | 2.4 | 2.5 | 2.3 | 2.5 |
| LOI, autoclave aged (%) | 2.5 | 2.6 | 2.5 | 2.5 | 2.5 | 2.5 |
| LOI, water bath aged (%) | 1.3 | 2.2 | 2.2 | 2.3 | 1.8 | 2.2 |
| Reaction loss (%) | 8 | — | 6 | — | 8 | — |
| Binder solubility (%) | 44 | 15 | 7 | 8 | 22 | 13 |
| Bar weight (g per bar) | 26.0 | 26.3 | 26.2 | 26.5 | 27.2 | 26.3 |
| Water absorption, 3 h (%) | 17 | 4 | 11 | 5 | 13 | 4 |
| Water absorption, 24 h (%) | 23 | 9 | 18 | 11 | 19 | 9 |

^{[a]} Of protein.
^{[b]} Of protein + crosslinker.

TABLE 1-5
Tannin amount study

| Example | 10 | 10rt | 2 | 2rt | 11 | 11rt | 12 | 12rt | 13 | 13rt |
|---|---|---|---|---|---|---|---|---|---|---|
| Binder composition | | | | | | | | | | |
| Protein (%-wt.) ^{[a]} | | | | | | | | | | |
| IMAGEL ® LA gelatin (A, 120 bloom) | 100 | 100 | 100 | 100 | 100 | 100 | 100 | 100 | 100 | 100 |
| IMAGEL ® RA gelatin (A, 180 bloom) | — | — | — | — | — | — | — | — | — | — |
| IMAGEL ® LB gelatin (B, 122 bloom) | — | — | — | — | — | — | — | — | — | — |
| Fish gelatin (250 bloom) | — | — | — | — | — | — | — | — | — | — |
| Glustar 100 wheat protein | — | — | — | — | — | — | — | — | — | — |
| Hemp protein | — | — | — | — | — | — | — | — | — | — |
| Crosslinker (%-wt.) ^{[a]} | | | | | | | | | | |
| Quebracho Idusol ATO (sulfonated) | 2.5 | 2.5 | 5 | 5 | 10 | 10 | 20 | 20 | 35 | 35 |
| Quebracho tannin (condensed) | — | — | — | — | — | — | — | — | — | — |
| Chestnut tree tannin (hydrolysable) | — | — | — | — | — | — | — | — | — | — |
| Fatty acid ester of glycerol ^{[b]} | | | | | | | | | | |
| Linseed oil (Leinöl Firnis) | 5.1 | 5.1 | 5 | 5 | 4.8 | 4.8 | 4.4 | 4.4 | 4.0 | 4.0 |
| Linseed oil (Borup Jomfru) | — | — | — | — | — | — | — | — | — | — |
| Coconut oil | — | — | — | — | — | — | — | — | — | — |
| Base (%-wt.) ^{[b]} | | | | | | | | | | |
| Sodium hydroxide | 0.73 | 0.73 | 0.72 | 0.72 | 0.74 | 0.74 | 0.73 | 0.73 | 0.83 | 0.83 |
| Calcium hydroxide | — | — | — | — | — | — | — | — | — | — |
| Additive ^{[b]} | | | | | | | | | | |
| Silane | 0.2 | 0.2 | 0.2 | 0.2 | 0.2 | 0.2 | 0.2 | 0.2 | 0.2 | 0.2 |
| Binder mixing and bar manufacture | | | | | | | | | | |
| Binder component solids content (%) | 20.0 | 20.0 | 20.0 | 20.0 | 20.0 | 20.0 | 20.0 | 20.0 | 17.5 | 17.5 |
| pH of binder mixture | 7.3 | 7.3 | 7.3 | 7.3 | 7.2 | 7.2 | 7.3 | 7.3 | 7.5 | 7.5 |
| Curing temperature (° C.) | 175 | rt | 175 | rt | 175 | rt | 175 | rt | 175 | rt |
| Bar properties | | | | | | | | | | |
| Mechanical strength, unaged (kN) | 0.77 | 0.68 | 0.71 | 0.65 | 0.59 | 0.58 | 0.56 | 0.44 | 0.40 | 0.26 |
| Mechanical strength, AC aged (kN) | 0.64 | 0.52 | 0.69 | 0.65 | 0.54 | 0.67 | 0.48 | 0.49 | 0.28 | 0.25 |
| Mechanical strength, WB aged (kN) | 0.14 | 0.33 | 0.20 | 0.45 | 0.23 | 0.42 | 0.24 | 0.38 | 0.19 | 0.21 |
| LOI, unaged (%) | 2.4 | 2.6 | 2.4 | 2.6 | 2.4 | 2.6 | 2.4 | 2.6 | 2.4 | 2.6 |
| LOI, autoclave aged (%) | 2.5 | 2.6 | 2.5 | 2.6 | 2.5 | 2.6 | 2.5 | 2.5 | 2.5 | 2.6 |
| LOI, water bath aged (%) | 1.0 | 2.0 | 1.3 | 2.2 | 1.6 | 2.2 | 1.8 | 2.2 | 1.8 | 2.2 |
| Reaction loss (%) | 7 | — | 8 | — | 7 | — | 8 | — | 8 | — |
| Binder solubility (%) | 54 | 21 | 44 | 15 | 32 | 14 | 23 | 13 | 22 | 16 |
| Bar weight (g per bar) | 26.1 | 26.2 | 26.0 | 26.3 | 25.7 | 26.2 | 26.0 | 25.5 | 26.1 | 26.2 |
| Water absorption, 3 h (%) | 13 | 4 | 17 | 4 | 17 | 4 | 13 | 5 | 11 | 6 |
| Water absorption, 24 h (%) | 25 | 9 | 23 | 9 | 23 | 10 | 19 | 10 | 17 | 11 |

^{[a]} Of protein.
^{[b]} Of protein + crosslinker.

TABLE 1-6
Fatty acid ester of glycerol study

| Example | 2 | 2rt | 14 | 14rt | 15 | 15rt |
|---|---|---|---|---|---|---|
| Binder composition | | | | | | |
| Protein (%-wt.) ^{[a]} | | | | | | |
| IMAGEL ® LA gelatin (A, 120 bloom) | 100 | 100 | 100 | 100 | 100 | 100 |
| IMAGEL ® RA gelatin (A, 180 bloom) | — | — | — | — | — | — |
| IMAGEL ® LB gelatin (B, 122 bloom) | — | — | — | — | — | — |
| Fish gelatin (250 bloom) | — | — | — | — | — | — |
| Glustar 100 wheat protein | — | — | — | — | — | — |
| Hemp protein | — | — | — | — | — | — |
| Crosslinker (%-wt.) ^{[a]} | | | | | | |
| Quebracho Idusol ATO (sulfonated) | 5 | 5 | 5 | 5 | 5 | 5 |
| Quebracho tannin (condensed) | — | — | — | — | — | — |
| Chestnut tree tannin (hydrolysable) | — | — | — | — | — | — |
| Fatty acid ester of glycerol ^{[b]} | | | | | | |
| Linseed oil (Leinöl Firnis) | 5 | 5 | — | — | — | — |
| Linseed oil (Borup Jomfru) | — | — | 5 | 5 | — | — |
| Coconut oil | — | — | — | — | 5 | 5 |
| Base (%-wt.) ^{[b]} | | | | | | |
| Sodium hydroxide | 0.72 | 0.72 | 0.74 | 0.74 | 0.74 | 0.74 |
| Calcium hydroxide | — | — | — | — | — | — |
| Additive ^{[b]} | | | | | | |
| Silane | 0.2 | 0.2 | 0.2 | 0.2 | 0.2 | 0.2 |
| Binder mixing and bar manufacture | | | | | | |
| Binder component solids content (%) | 20.0 | 20.0 | 20.0 | 20.0 | 20.0 | 20.0 |
| pH of binder mixture | 7.3 | 7.3 | 7.3 | 7.3 | 7.3 | 7.3 |
| Curing temperature (° C.) | 175 | rt | 175 | rt | 175 | rt |
| Bar properties | | | | | | |
| Mechanical strength, unaged (kN) | 0.71 | 0.65 | 0.74 | 0.62 | 0.74 | 0.70 |
| Mechanical strength, AC aged (kN) | 0.69 | 0.65 | 0.75 | 0.61 | 0.80 | 0.60 |
| Mechanical strength, WB aged (kN) | 0.20 | 0.45 | 0.17 | 0.43 | 0.17 | 0.48 |
| LOI, unaged (%) | 2.4 | 2.6 | 2.4 | 2.5 | 2.4 | 2.5 |
| LOI, autoclave aged (%) | 2.5 | 2.6 | 2.5 | 2.5 | 2.5 | 2.5 |
| LOI, water bath aged (%) | 1.3 | 2.2 | 1.1 | 2.2 | 1.1 | 2.3 |
| Reaction loss (%) | 8 | — | 7 | — | 7 | — |
| Binder solubility (%) | 44 | 15 | 51 | 12 | 53 | 11 |
| Bar weight (g per bar) | 26.0 | 26.3 | 26.7 | 26.7 | 26.5 | 26.8 |
| Water absorption, 3 h (%) | 17 | 4 | 18 | 4 | 9 | 4 |
| Water absorption, 24 h (%) | 23 | 9 | 23 | 8 | 17 | 9 |

^{[a]} Of protein.
^{[b]} Of protein + crosslinker.

TABLE 1-7
Fatty acid esteer of glycerol amount study

| Example | 16 | 16rt | 2 | 2rt | 17 | 17rt | 18 | 18rt | 19 | 19rt |
|---|---|---|---|---|---|---|---|---|---|---|
| Binder composition | | | | | | | | | | |
| Protein (%-wt.) ^{[a]} | | | | | | | | | | |
| IMAGEL ® LA gelatin (A, 120 bloom) | 100 | 100 | 100 | 100 | 100 | 100 | 100 | 100 | 100 | 100 |
| IMAGEL ® RA gelatin (A, 180 bloom) | — | — | — | — | — | — | — | — | — | — |
| IMAGEL ® LB gelatin (B, 122 bloom) | — | — | — | — | — | — | — | — | — | — |
| Fish gelatin (250 bloom) | — | — | — | — | — | — | — | — | — | — |
| Glustar 100 wheat protein | — | — | — | — | — | — | — | — | — | — |
| Hemp protein | — | — | — | — | — | — | — | — | — | — |
| Crosslinker (%-wt.) ^{[a]} | | | | | | | | | | |
| Quebracho Idusol ATO (sulfonated) | 5 | 5 | 5 | 5 | 5 | 5 | 5 | 5 | 5 | 5 |
| Quebracho tannin (condensed) | — | — | — | — | — | — | — | — | — | — |
| Chestnut tree tannin (hydrolysable) | — | — | — | — | — | — | — | — | — | — |
| Fatty acid ester of glycerol ^{[b]} | | | | | | | | | | |
| Linseed oil (Leinöl Firnis) | 2.5 | 2.5 | 5 | 5 | 10 | 10 | 20 | 20 | 50 | 50 |
| Linseed oil (Borup Jomfru) | — | — | — | — | — | — | — | — | — | — |
| Coconut oil | — | — | — | — | — | — | — | — | — | — |
| Base (%-wt.) ^{[b]} | | | | | | | | | | |
| Sodium hydroxide | 0.70 | 0.70 | 0.72 | 0.72 | 0.71 | 0.71 | 0.76 | 0.76 | 0.74 | 0.74 |
| Calcium hydroxide | — | — | — | — | — | — | — | — | — | — |
| Additive ^{[b]} | | | | | | | | | | |
| Silane | 0.2 | 0.2 | 0.2 | 0.2 | 0.2 | 0.2 | 0.2 | 0.2 | 0.2 | 0.2 |
| Binder mixing and bar manufacture | | | | | | | | | | |
| Binder component solids content (%) | 20.0 | 20.0 | 20.0 | 20.0 | 20.0 | 20.0 | 20.0 | 20.0 | 20.0 | 20.0 |
| pH of binder mixture | 7.3 | 7.3 | 7.3 | 7.3 | 7.2 | 7.2 | 7.3 | 7.3 | 7.2 | 7.2 |
| Curing temperature (° C.) | 175 | rt | 175 | rt | 175 | rt | 175 | rt | 175 | rt |
| Bar properties | | | | | | | | | | |
| Mechanical strength, unaged (kN) | 0.68 | 0.67 | 0.71 | 0.65 | 0.65 | 0.57 | 0.69 | 0.59 | 0.45 | 0.61 |
| Mechanical strength, AC aged (kN) | 0.63 | 0.64 | 0.69 | 0.65 | 0.58 | 0.58 | 0.61 | 0.55 | 0.50 | 0.57 |
| Mechanical strength, WB aged (kN) | 0.14 | 0.54 | 0.20 | 0.45 | 0.22 | 0.44 | 0.19 | 0.48 | 0.27 | 0.48 |
| LOI, unaged (%) | 2.4 | 2.6 | 2.4 | 2.6 | 2.4 | 2.6 | 2.5 | 2.6 | 2.8 | 3.0 |
| LOI, autoclave aged (%) | 2.5 | 2.6 | 2.5 | 2.6 | 2.6 | 2.6 | 2.6 | 2.6 | 2.9 | 2.9 |
| LOI, water bath aged (%) | 1.3 | 2.3 | 1.3 | 2.2 | 1.4 | 2.3 | 1.8 | 2.3 | 2.4 | 2.7 |
| Reaction loss (%) | 9 | — | 8 | — | 8 | — | 7 | — | 7 | — |
| Binder solubility (%) | 47 | 13 | 44 | 15 | 43 | 14 | 27 | 11 | 12 | 10 |
| Bar weight (g per bar) | 25.7 | 26.0 | 26.0 | 26.3 | 25.6 | 26.1 | 26.5 | 26.6 | 27.1 | 27.4 |
| Water absorption, 3 h (%) | 28 | 4 | 17 | 4 | 19 | 4 | 12 | 6 | 9 | 5 |
| Water absorption, 24 h (%) | 34 | 10 | 23 | 9 | 23 | 9 | 20 | 12 | 21 | 9 |

^{[a]} Of protein.
^{[b]} Of protein + crosslinker.

TABLE 1-8
Binder pH study

| Example | 20 | 20rt | 2 | 2rt | 21 | 21rt |
|---|---|---|---|---|---|---|
| Binder composition | | | | | | |
| Protein (%-wt.) ^{[a]} | | | | | | |
| IMAGEL ® LA gelatin (A, 120 bloom) | 100 | 100 | 100 | 100 | 100 | 100 |
| IMAGEL ® RA gelatin (A, 180 bloom) | — | — | — | — | — | — |
| IMAGEL ® LB gelatin (B, 122 bloom) | — | — | — | — | — | — |
| Fish gelatin (250 bloom) | — | — | — | — | — | — |
| Glustar 100 wheat protein | — | — | — | — | — | — |
| Hemp protein | — | — | — | — | — | — |
| Crosslinker (%-wt.) ^{[a]} | | | | | | |
| Quebracho Idusol ATO (sulfonated) | 5 | 5 | 5 | 5 | 5 | 5 |
| Quebracho tannin (condensed) | — | — | — | — | — | — |
| Chestnut tree tannin (hydrolysable) | — | — | — | — | — | — |
| Fatty acid ester of glycerol ^{[b]} | | | | | | |
| Linseed oil (Leinöl Firnis) | 5 | 5 | 5 | 5 | 5 | 5 |
| Linseed oil (Borup Jomfru) | — | — | — | — | — | — |
| Coconut oil | — | — | — | — | — | — |
| Base (%-wt.) ^{[b]} | | | | | | |
| Sodium hydroxide | — | — | 0.72 | 0.72 | 1.63 | 1.63 |
| Calcium hydroxide | — | — | — | — | — | — |
| Additive ^{[b]} | | | | | | |
| Silane | 0.2 | 0.2 | 0.2 | 0.2 | 0.2 | 0.2 |
| Binder mixing and bar manufacture | | | | | | |
| Binder component solids content (%) | 20.0 | 20.0 | 20.0 | 20.0 | 20.0 | 20.0 |
| pH of binder mixture | 5.1 | 5.1 | 7.3 | 7.3 | 9.0 | 9.0 |
| Curing temperature (° C.) | 175 | rt | 175 | rt | 175 | rt |
| Bar properties | | | | | | |
| Mechanical strength, unaged (kN) | 0.58 | 0.62 | 0.71 | 0.65 | 0.67 | 0.66 |
| Mechanical strength, AC aged (kN) | 0.60 | 0.62 | 0.69 | 0.65 | 0.65 | 0.61 |
| Mechanical strength, WB aged (kN) | 0.11 | 0.61 | 0.20 | 0.45 | 0.39 | 0.42 |
| LOI, unaged (%) | 2.4 | 2.6 | 2.4 | 2.6 | 2.4 | 2.5 |
| LOI, autoclave aged (%) | 2.5 | 2.6 | 2.5 | 2.6 | 2.5 | 2.5 |
| LOI, water bath aged (%) | 0.9 | 2.3 | 1.3 | 2.2 | 2.0 | 2.2 |
| Reaction loss (%) | 8 | — | 8 | — | 7 | — |
| Binder solubility (%) | 63 | 10 | 44 | 15 | 16 | 14 |
| Bar weight (g per bar) | 25.6 | 26.0 | 26.0 | 26.3 | 26.5 | 26.4 |
| Water absorption, 3 h (%) | 18 | 3 | 17 | 4 | 16 | 5 |
| Water absorption, 24 h (%) | 23 | 8 | 23 | 9 | 22 | 11 |

^{[a]} Of protein.
^{[b]} Of protein + crosslinker.

TABLE 1-9
Metal ion study

| Example | 2 | 2rt | 22 | 22rt |
|---|---|---|---|---|
| Binder composition | | | | |
| Protein (%-wt.) ^{[a]} | | | | |
| IMAGEL ® LA gelatin | 100 | 100 | 100 | 100 |
| (A, 120 bloom) | | | | |
| IMAGEL ® RA gelatin | — | — | — | — |
| (A, 180 bloom) | | | | |
| IMAGEL ® LB gelatin | — | — | — | — |
| (B, 122 bloom) | | | | |
| Fish gelatin (250 bloom) | — | — | — | — |
| Glustar 100 wheat protein | — | — | — | — |
| Hemp protein | — | — | — | — |
| Crosslinker (%-wt.) ^{[a]} | | | | |
| Quebracho Idusol ATO | 5 | 5 | 5 | 5 |
| (sulfonated) | | | | |
| Quebracho tannin | — | — | — | — |
| (condensed) | | | | |
| Chestnut tree tannin | — | — | — | — |
| (hydrolysable) | | | | |
| Fatty acid ester of | | | | |
| glycerol ^{[b]} | | | | |
| Linseed oil (Leinöl Firnis) | 5 | 5 | 5 | 5 |
| Linseed oil (Borup Jomfru) | — | — | — | — |
| Coconut oil | — | — | — | — |
| Base (%-wt.) ^{[b]} | | | | |
| Sodium hydroxide | 0.72 | 0.72 | — | — |
| Calcium hydroxide | — | — | 0.77 | 0.77 |
| Additive ^{[b]} | | | | |
| Silane | 0.2 | 0.2 | 0.2 | 0.2 |
| Binder mixing and bar | | | | |
| manufacture | | | | |
| Binder component solids | 20.0 | 20.0 | 20.0 | 20.0 |
| content (%) | | | | |
| pH of binder mixture | 7.3 | 7.3 | 7.2 | 7.2 |
| Curing temperature (° C.) | 175 | rt | 175 | rt |
| Bar properties | | | | |
| Mechanical strength, | 0.71 | 0.65 | 0.67 | 0.67 |
| unaged (kN) | | | | |
| Mechanical strength, | 0.69 | 0.65 | 0.67 | 0.55 |
| AC aged (kN) | | | | |
| Mechanical strength, | 0.20 | 0.45 | 0.21 | 0.58 |
| WB aged (kN) | | | | |
| LOI, unaged (%) | 2.4 | 2.6 | 2.4 | 2.6 |
| LOI, autoclave aged (%) | 2.5 | 2.6 | 2.5 | 2.6 |
| LOI, water bath aged (%) | 1.3 | 2.2 | 1.2 | 2.4 |
| Reaction loss (%) | 8 | — | 7 | — |
| Binder solubility (%) | 44 | 15 | 50 | 7 |
| Bar weight (g per bar) | 26.0 | 26.3 | 26.5 | 26.6 |
| Water absorption, 3 h (%) | 17 | 4 | 13 | 4 |
| Water absorption, 24 h (%) | 23 | 9 | 24 | 9 |

^{[a]} Of protein.
^{[b]} Of protein + crosslinker.

TABLE 1-10
Silane study

| Example | 23 | 23rt | 2 | 2rt |
|---|---|---|---|---|
| Binder composition | | | | |
| Protein (%-wt.) ^{[a]} | | | | |
| IMAGEL ® LA gelatin | 100 | 100 | 100 | 100 |
| (A, 120 bloom) | | | | |
| IMAGEL ® RA gelatin | — | — | — | — |
| (A, 180 bloom) | | | | |
| IMAGEL ® LB gelatin | — | — | — | — |
| (B, 122 bloom) | | | | |
| Fish gelatin (250 bloom) | — | — | — | — |
| Glustar 100 wheat protein | — | — | — | — |
| Hemp protein | — | — | — | — |
| Crosslinker (%-wt.) ^{[a]} | | | | |
| Quebracho Idusol ATO | 5 | 5 | 5 | 5 |
| (sulfonated) | | | | |
| Quebracho tannin | — | — | — | — |
| (condensed) | | | | |
| Chestnut tree tannin | — | — | — | — |
| (hydrolysable) | | | | |
| Fatty acid ester of | | | | |
| glycerol ^{[b]} | | | | |
| Linseed oil (Leinöl Firnis) | 5 | 5 | 5 | 5 |
| Linseed oil (Borup Jomfru) | — | — | — | — |
| Coconut oil | — | — | — | — |
| Base (%-wt.) ^{[b]} | | | | |
| Sodium hydroxide | 0.85 | 0.85 | 0.72 | 0.72 |
| Calcium hydroxide | — | — | — | — |
| Additive ^{[b]} | | | | |
| Silane | — | — | 0.2 | 0.2 |
| Binder mixing and bar | | | | |
| manufacture | | | | |
| Binder component solids | 20.0 | 20.0 | 20.0 | 20.0 |
| content (%) | | | | |
| pH of binder mixture | 7.5 | 7.5 | 7.3 | 7.3 |
| Curing temperature (° C.) | 175 | rt | 175 | rt |
| Bar properties | | | | |
| Mechanical strength, | 0.69 | 0.59 | 0.71 | 0.65 |
| unaged (kN) | | | | |
| Mechanical strength, | 0.62 | 0.54 | 0.69 | 0.65 |
| AC aged (kN) | | | | |
| Mechanical strength, | 0.29 | 0.40 | 0.20 | 0.45 |
| WB aged (kN) | | | | |
| LOI, unaged (%) | 2.3 | 2.7 | 2.4 | 2.6 |
| LOI, autoclave aged (%) | 2.5 | 2.7 | 2.5 | 2.6 |
| LOI, water bath aged (%) | 1.8 | 2.3 | 1.3 | 2.2 |
| Reaction loss (%) | 12 | — | 8 | — |
| Binder solubility (%) | 24 | 12 | 44 | 15 |
| Bar weight (g per bar) | 25.8 | 25.6 | 26.0 | 26.3 |
| Water absorption, 3 h (%) | 17 | 4 | 17 | 4 |
| Water absorption, 24 h (%) | 20 | 9 | 23 | 9 |

^{[a]} Of protein.
^{[b]} Of protein + crosslinker.

TABLE 1-11
Protein study

| Example | 2 | 2rt | 24 | 24rt | 25 | 25rt | 26 | 26rt |
|---|---|---|---|---|---|---|---|---|
| Binder composition | | | | | | | | |
| Protein (%-wt.) ^{[a]} | | | | | | | | |
| IMAGEL ® LA gelatin (A, 120 bloom) | 100 | 100 | 75 | 75 | 75 | 75 | 75 | 75 |
| IMAGEL ® RA gelatin (A, 180 bloom) | — | — | — | — | — | — | — | — |
| IMAGEL ® LB gelatin (B, 122 bloom) | — | — | — | — | — | — | — | — |
| Fish gelatin (250 bloom) | — | — | — | — | — | — | — | — |
| Glustar 100 wheat protein | — | — | 25 | 25 | — | — | — | — |
| Hemp protein | — | — | — | — | 25 | 25 | 25 | 25 |
| Crosslinker (%-wt.) ^{[a]} | | | | | | | | |
| Quebracho Idusol ATO (sulfonated) | 5 | 5 | 5 | 5 | 5 | 5 | 5 | 5 |
| Quebracho tannin (condensed) | — | — | — | — | — | — | — | — |
| Chestnut tree tannin (hydrolysable) | — | — | — | — | — | — | — | — |
| Fatty acid ester of glycerol ^{[b]} | | | | | | | | |
| Linseed oil (Leinöl Firnis) | 5 | 5 | 5 | 5 | 5 | 5 | — | — |
| Linseed oil (Borup Jomfru) | — | — | — | — | — | — | — | — |
| Coconut oil | — | — | — | — | — | — | — | — |
| Base (%-wt.) ^{[b]} | | | | | | | | |
| Sodium hydroxide | 0.72 | 0.72 | 0.65 | 0.65 | 0.74 | 0.74 | 0.78 | 0.78 |
| Calcium hydroxide | — | — | — | — | — | — | — | — |
| Additive ^{[b]} | | | | | | | | |
| Silane | 0.2 | 0.2 | 0.2 | 0.2 | 0.2 | 0.2 | 0.2 | 0.2 |
| Binder mixing and bar manufacture | | | | | | | | |
| Binder component solids content (%) | 20.0 | 20.0 | 20.0 | 20.0 | 20.0 | 20.0 | 20.0 | 20.0 |
| pH of binder mixture | 7.3 | 7.3 | 7.3 | 7.3 | 7.2 | 7.2 | 7.2 | 7.2 |
| Curing temperature (° C.) | 175 | rt | 175 | rt | 175 | rt | 175 | rt |
| Bar properties | | | | | | | | |
| Mechanical strength, unaged (kN) | 0.71 | 0.65 | 0.60 | 0.57 | 0.58 | 0.45 | 0.54 | 0.43 |
| Mechanical strength, AC aged (kN) | 0.69 | 0.65 | 0.45 | 0.67 | 0.45 | 0.40 | 0.50 | 0.39 |
| Mechanical strength, WB aged (kN) | 0.20 | 0.45 | 0.22 | 0.35 | 0.19 | 0.34 | 0.20 | 0.30 |
| LOI, unaged (%) | 2.4 | 2.6 | 2.4 | 2.5 | 2.4 | 2.5 | 2.3 | 2.5 |
| LOI, autoclave aged (%) | 2.5 | 2.6 | 2.5 | 2.5 | 2.5 | 2.5 | 2.5 | 2.5 |
| LOI, water bath aged (%) | 1.3 | 2.2 | 1.7 | 2.1 | 1.5 | 2.2 | 1.5 | 2.1 |
| Reaction loss (%) | 8 | — | 6 | — | 6 | — | 6 | — |
| Binder solubility (%) | 44 | 15 | 28 | 16 | 37 | 13 | 37 | 15 |
| Bar weight (g per bar) | 26.0 | 26.3 | 26.4 | 26.9 | 26.9 | 26.9 | 26.4 | 26.2 |
| Water absorption, 3 h (%) | 17 | 4 | 23 | 7 | 27 | 6 | 26 | 10 |
| Water absorption, 24 h (%) | 23 | 9 | 25 | 12 | 29 | 11 | 28 | 14 |

^{[a]} Of protein.
^{[b]} Of protein + crosslinker.

TABLE 1-12
Ammonia emissions during curing

| Example | 1 | 2 | 3 |
|---|---|---|---|
| Binder composition | | | |
| Protein (%-wt.) ^{[a]} | | | |
| IMAGEL ® LA gelatin | 100 | 100 | 100 |
| Crosslinker (%-wt.) ^{[a]} | | | |
| Quebracho Idusol ATO | 10 | 5 | 5 |
| Fatty acid ester of glycerol ^{[b]} | | | |
| Linseed oil (Leinöl Firnis) | — | — | 5 |
| Base (%-wt.) ^{[b]} | | | |
| Sodium hydroxide | — | 0.57 | 0.75 |
| Calcium hydroxide | 1.74 | — | — |
| Binder mixing and curing temperature | | | |
| Binder component solids content (%) | 15.0 | 15.0 | 15.0 |
| pH of binder mixture | 9.2 | 7.3 | 7.3 |
| Curing temperature (° C.) | 125 | 200 | 225 |
| Curing emission characteristics | | | |
| Relative ammonia emission index | 100 | 53 | 81 |

^{[a]} Of protein.
^{[b]} Of protein + crosslinker.

### Examples B—Production Examples

### Binder Mixing

To a stirred solution of NaOH (0.4 kg) in water (60 kg) at ambient temperature was added tannin (6.2 kg; Quebracho Extract Indusol ATO, Otto Dille). Stirring was continued until a deep-brown solution was obtained (pH 9.0).

A mixture of gelatin (125 kg; IMAGEL® LA, GELITA AG) in water (528 L) was stirred at approx. 50° C. until a clear solution was obtained (pH 5.1). Linseed oil (6.6 kg; Leintil Firnis, OLI-NATURA), sodium hydroxide (0.3 kg) and 40% silane (0.7 kg; Silquest VS 142, Momentive) were then added and stirring was continued at 50° C. (pH 6.3). The above tannin solution was then added and stirring was continued at 50° C. (pH 7.3). Alternatively, the components could be mixed in an in-line fashion.

### Binder and Additive Dosing

The above binder mixture was diluted as appropriate/required with water and dosed to the cascade spinner. To decrease dust form the resulting stone wool product and to render the stone wool product suitably hydrophobic, impregnation oil (Process oil 815, Brenntag) and hydrophobizing agent (Silres 5140, Wacker) were each added in-line and/or separately in an amount that corresponds to 0.2% of the stone wool weight.

### Curing

The stone wool product was cured with air heated to a temperature that resulted in an inner/surface temperature of the wool exiting the curing oven in the vicinity of 200° C.

### Results

| | Norm/ | | Mineral wool |
|---|---|---|---|
| Product properties | procedure | Specifications | product |
| LOI (%) | | — | 5.0 |
| Oil content (%) | | — | 0.22 |
| Compression strength | EN 826 | ≥20 | 20 |
| 10% σ₁₀ (kPa) | | | |
| Density (kg/m³) | EN 1602 | 80 | 83.3 |
| Delamination σₘₜ (kPa) | EN 1607 | ≥7.5 | 8.5 |
| Density (kg/m³) | EN 1602 | 80 | 81.3 |
| Water uptake (kg/m²) | EN 1609 | ≤1 | 0.95 |

1. A method for producing a mineral wool product comprising:
contacting mineral fibres with a formaldehyde-free binder composition for mineral fibres, the formaldehyde-free binder composition comprising:
at least one phenol containing compound, and
at least one protein, and
curing the binder composition at a temperature of >150° C.-250° C., such as 175° C.-225° C.

2. The method according to claim 1, further comprising:
making a melt of raw materials;
fibrerising the melt by a fibre forming apparatus to form the mineral fibres;
providing the mineral fibres in the form of a collected web;
mixing the binder composition with the mineral fibres before, during or after the provision of the collected web to form a mixture of the mineral fibres and the binder composition;
curing the mixture of the mineral fibres and the binder composition.

3. The method according to claim 1, wherein the at least one phenol containing compound comprises a phenol containing compound selected from the group consisting of simple phenolics, hydroxybenzoic acids, hydroxybenzoic aldehydes, hydroxyacetophenones, hydroxyphenylacetic acids, cinnamic acids, cinnamic acid esters, cinnamyl aldehydes, cinnamyl alcohols, coumarins, isocoumarins, chromones, flavonoids, chalcones, dihydrochalcones, aurones, flavanones, flavanonols, flavans, leucoanthocyanidins, flavan-3-ols, flavones, anthocyanidins, deoxyanthocyanidines, anthocyanins, biflavonyls, benzophenones, xanthones, stilbenes, betacyanins, polyphenols and/or polyhydroxyphenols, lignans, neolignans (dimers or oligomers from coupling of monolignols such as p-coumaryl alcohol, coniferyl alcohol and sinapyl alcohol), lignins (synthesized primarily from the monolignol precursors p-coumaryl alcohol, coniferyl alcohol and sinapyl alcohol), tannins, tannates (salts of tannins), condensed tannins (proanthocyanidins), hydrolysable tannins, gallotannins, ellagitannins, complex tannins, tannic acid, phlobabenes, phlorotannins, and sulfonated phenolic containing compounds.

4. The method according to claim 1, wherein the tannin is selected from one or more components from the group consisting of tannic acid, condensed tannins (proanthocyanidins), sulfonated tannins, hydrolysable tannins, gallotannins, ellagitannins, complex tannins, and/or tannin originating from one or more of oak, chestnut, staghorn sumac, fringe cups, quebracho, acacia, mimosa, black wattle bark, grape, gallnut, gambier, myrobalan, tara, valonia, and eucalyptus.

5. The method according to claim 1, wherein the phenol containing compound comprises one or more synthetic or semisynthetic molecules that contain phenols, polyphenols, such as a proteins, peptides, peptoids or arylopeptoids modified with phenol containing side chains, such as dendrimers decorated with phenol containing side chains.

6. The method according to claim 1, wherein content of the at least one phenol containing compound, such as in form of tannin is 1 to 60 wt. %, or 2 to 60 wt. %, or 3 to 50 wt. %, or 4 to 40 wt. %, or 5 to 35 wt. %, or 2.5 to 15 wt. %, or 4 to 12 wt. %, based on dry protein basis.

7. The method according to claim 1, wherein the at least one protein is selected from the group consisting of proteins from animal sources, including collagen, gelatin, hydrolysed gelatin, and protein from milk (casein, whey), eggs; proteins from jellyfish, proteins produced by recombinant techniques; proteins from insects, such as silk worms, such as sericin; proteins from vegetable sources, including proteins from algae, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, proteins produced by recombinant techniques; and polyphenolic proteins such as mussel foot protein.

8. The method according to claim 1, wherein:
the at least one protein of the binder composition comprises at least two proteins;
one of the at least two proteins is at least one protein selected from the group consisting of proteins from animal sources, including collagen, gelatin, hydrolysed gelatin, and protein from milk (casein, whey), eggs; proteins from jellyfish proteins produced by recombinant techniques; proteins from insects, such as silk worms, such as sericin, such as mussel foot protein; and
another of the at least two proteins is at least one protein selected from &group of proteins from vegetable sources, including proteins from algaes, legumes, cereals, whole grains, nuts, seeds and fruits, like protein from buckwheat, oats, rye, millet, maize (corn), rice, wheat, bulgur, sorghum, amaranth, quinoa, soybeans (soy protein), lentils, kidney beans, white beans, mung beans, chickpeas, cowpeas, lima beans, pigeon peas, lupines, wing beans, almonds, Brazil nuts, cashews, pecans, walnuts, rapeseeds, cotton seeds, pumpkin seeds, hemp seeds, sesame seeds, and sunflower seeds, and proteins produced by recombinant techniques.

9. The method according to claim 1, wherein the binder composition does not comprise a protein from soybeans (soy protein).

10. The method according to claim 1, wherein the at least one protein contains 50 to 400, or 100 to 300 (hydroxy proline+proline) residues per 1000 amino acid residues.

11. The method according to claim 1, wherein the binder composition further comprises an additive selected from the group of an oxidiser, such as tyrosinase, a pH-adjuster, preferably in form of a base, such as organic base, such as amine or salts thereof, inorganic bases, such as ammonia or salts thereof.

12. The method according to claim 1, wherein the binder composition has a pH of 4.5 to 9.5, or 6.0 to 8.0.

13. The method according to claim 1, wherein content of the at least one protein is 1 to 99 wt. %, or 3 to 97 wt. %, or 5 to 95 wt. %, or 10 to 90 wt. %, or 10 to 80 wt. %, based on content of the at least one phenol containing compound and the at least one protein.

14. The method according to claim 1, wherein the binder composition comprises at least one divalent metal cation M²⁺ containing compound.

15. The method according to claim 14, wherein the binder composition comprises the at least one divalent metal cation compound in an amount of 0.1 wt. % to 10 wt. %, or 0.2 wt. % to 8 wt. %, or 0.3 wt. % to 5 wt. %, or 0.4 wt. % to 4.3 wt. %, or 1.0 wt. % to 4.3 wt. %, based on a combined dry weight of the phenol containing compound and the at least one protein.

16. The method according to claim 1, wherein the binder composition further comprises at least one fatty acid ester of glycerol.

17. The method according to claim 16, wherein the at least one fatty acid ester of glycerol is selected from one or more components from the group consisting of linseed oil, coconut oil, corn oil, canola oil, cottonseed oil, olive oil, palm oil, peanut oil (ground nut oil), rapeseed oil, including canola oil, safflower oil, sesame oil, soybean oil, and sunflower oil.

18. The method according to claim 16, wherein content of fatty acid ester of glycerol is 0.6 to 60, or 0.5 to 40, or 1 to 30, or 1.5 to 16, or 3 to 10, or 4 to 7.5 wt. % based on a dry weight of the at least one protein and the at least one phenol containing compound.

19. (canceled)
